(19) United States
(12) Patent Application Publication
(10) Pub. No.: US 2022/0220335 A1
(43) Pub. Date: Jul. 14, 2022

(54) COATING COMPOSITIONS AND SYSTEMS AND METHODS OF APPLYING SUCH COATING COMPOSITIONS

(71) Applicant: PPG Industries Ohio, Inc., Cleveland, OH (US)

(72) Inventors: Sven Reil, Grossbottwar (DE); Maria E. Buchholz, Weingarten (DE); John M. Furar, Pittsburgh, PA (US); Wolfgang Klaeger, Leonberg (DE); Juergen Klenk, Ingersheim (DE); Gerolf M. Von Kuerthy, Sulz (DE); Lisa Leffrang, Grosswallstadt (DE); Simone A. Osswald, Besigheim (DE); Richard J. Sadvary, Tarentum, PA (US); Stephane Schoch, Aschaffenburg (DE); Marco Seemann, Kleinheubach (DE); Christopher Stoehr, Erlenbach a. Main (DE)

(73) Assignee: PPG Industries Ohio, Inc., Cleveland, OH (US)

(21) Appl. No.: 17/611,205

(22) PCT Filed: May 12, 2020
(86) PCT No.: PCT/US2020/032505

§ 371 Date: Nov. 15, 2021

Related U.S. Application Data
(60) Provisional application No. 62/846,888, filed on May 13, 2019.

(51) Int. Cl. C09D 167/00; C09D 133/08; C09D 7/20; C09D 7/43; C09D 7/61; B05D 1/02; B05D 7/14; B05D 7/00; B05D 5/06

(52) U.S. Cl. CPC C09D 167/00; C09D 133/08; C09D 7/20; C09D 7/43; C09D 7/61; B05D 1/02; B05D 2601/00; B05D 7/574; B05D 5/06; B05D 2420/01; B05D 2420/02; B05D 2502/00; B05D 2508/00; B05D 7/14

(57) ABSTRACT

A coating composition for precision application includes: a coating composition including a film-forming resin dispersed in an aqueous medium; a crosslinker reactive with the film-forming resin; a rheology modifier; a colorant; and a swelling solvent that swells the film-forming resin. The solids content of the coating composition is less than 25 weight %, based on the total weight of the coating composition. A system and method for precision application of a coating composition over at least a portion of a substrate are also disclosed. A substrate coated with a multi-layer coating system is also disclosed.

### FIELD OF THE INVENTION

The present invention relates to coating compositions as well as systems and processes of applying such coating compositions, and to substrates coated with a multi-layer coating system.

### BACKGROUND OF THE INVENTION

Coatings are applied to a wide variety of substrates to provide color and other visual effects, corrosion resistance, abrasion resistance, chemical resistance, and the like. Such coatings can also be applied to substrates to provide various designs and patterns. For example, coatings can be applied to automotive substrates to provide two or more different colors on different portions of the substrate. However, to form different designs and patterns, masking materials are typically placed over different portions of the substrate and multiple applications of different coating compositions are applied over the substrate.

In order to improve the coating process, devices have been developed to apply compositions without overspray (application of the composition over an unintended portion of the substrate), thereby eliminating the need for masking materials and multiple coating applications. While these devices improve the coating process, coating compositions having the desired coating properties, such as a desired color and/or cure profile, must be able to be applied from these devices to form a coating layer over the substrate.

It is accordingly an objective of the present invention to provide coating compositions that can be applied to substrates with devices that prevent overspray and which also provide desired coating properties including color, leveling, comparatively low cure temperatures, and the like.

### SUMMARY OF THE INVENTION

The present invention is directed to a coating composition for precision application including: a coating composition including a film-forming resin dispersed in an aqueous medium; a crosslinker reactive with the film-forming resin; a rheology modifier; a colorant; and a swelling solvent that swells the film-forming resin. The solids content of the coating composition is less than 25 weight %, based on the total weight of the coating composition.

The present invention is also directed to a system for precision application of a coating composition over at least a portion of a substrate. The system includes a coating composition including: a film-forming resin dispersed in an aqueous medium; a crosslinker reactive with the film-forming resin; a rheology modifier; a colorant; and a swelling solvent that swells the film-forming resin. The solids content of the coating composition is less than 25 weight %, based on the total weight of the coating composition. The system includes a device configured to apply the coating composition over at least a portion of the substrate without overspray.

The present invention is also directed to a substrate coated with a multi-layer coating system. The multi-layer coating system includes: a first basecoat layer positioned over at least a portion of the substrate and a second basecoat layer positioned over at least a portion of the first basecoat layer. The first basecoat layer is formed from a first basecoat composition that when cured to form a layer having a thickness of 35 μm by baking at 80° C. for 30 minutes, the layer achieves 100 MEK double rubs as measured according to ASTM D5402-19. The second basecoat layer is formed from a second basecoat composition including: a film-forming resin dispersed in an aqueous medium; a crosslinker reactive with the film-forming resin; and a colorant, where the solids content of the second basecoat composition is less than 25 weight %, based on the total weight of the second basecoat composition.

### BRIEF DESCRIPTION OF THE DRAWING

FIG. 1 shows a vehicle coated using the coating composition, system, and method according to the present invention and constituting a substrate coated with a multi-layer coating system according to the present invention.

### DESCRIPTION OF THE INVENTION

For purposes of the following detailed description, it is to be understood that the invention may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and the plural encompasses the singular, unless specifically stated otherwise. In addition, in this application, the use of “or” means “and/or” unless specifically stated otherwise, even though “and/or” may be explicitly used in certain instances. Further, in this application, the use of “a” or “an” means “at least one” unless specifically stated otherwise. For example, “a” film-forming resin, “a” crosslinker, and the like refer to one or more of any of these items.

As used herein, the transitional term “comprising” (and other comparable terms, e.g., “containing” and “including”) is “open-ended” and open to the inclusion of unspecified matter. Although described in terms of “comprising”, the terms “consisting essentially of” and “consisting of” are also within the scope of the invention.

As indicated, the present invention relates to a coating composition for precision application, a system for precision application of a coating composition over at least a portion of a substrate, a substrate coated with a multi-layer coating system, and method for precision application of a coating composition over at least a portion of a substrate. As used herein, “precision application” refers to the ability to apply the coating composition over a desired region of a substrate without applying the coating composition over an undesired region of the substrate. This may enable application of the coating composition over the desired region of the substrate without masking the undesired region of the substrate with a removable material (such as taping materials for example).

In accordance with the present invention, the coating composition comprises a film-forming resin dispersed in an aqueous medium, a crosslinker reactive with the film-forming resin, and a colorant, where the solids content of the coating composition is less than 25 weight %, based on the total weight of the coating composition. The coating composition may include a rheology modifier. The coating composition may include a swelling solvent that swells the film-forming resin.

As used herein, a “film-forming resin” refers to a self-supporting continuous film on at least a horizontal surface of a substrate upon removal of any diluents or carriers present in the composition or upon curing. Further, as used herein, the term “resin” is used interchangeably with “polymer,” and the term polymer refers to oligomers and homopolymers (e.g., prepared from a single monomer species), copolymers (e.g., prepared from at least two monomer species), terpolymers (e.g., prepared from at least three monomer species), graft copolymers, and block copolymers.

The terms “curable”, “cure”, and the like, as used in connection with a coating composition, means that at least a portion of the components that make up the coating composition are polymerizable and/or crosslinkable. The coating composition of the present invention can be cured at ambient conditions, with heat, or with other means such as actinic radiation. The term “actinic radiation” refers to electromagnetic radiation that can initiate chemical reactions. Actinic radiation includes, but is not limited to, visible light, ultraviolet (UV) light, X-ray, and gamma radiation. Further, “ambient conditions” refers to the conditions of the surrounding environment (e.g., the temperature, humidity, and pressure of the room or outdoor environment in which the substrate is located such as, for example, at a temperature of from 20° C. to 25° C. and at a relative humidity in the air of 35% to 75%).

The film-forming resin of the present invention can comprise: polymeric core-shell particles in which a polymeric core is at least partially encapsulated by a polymeric shell; a self-emulsifying dispersion polymer; or a combination thereof.

As used herein, a core-shell particle in which the core is at least partially encapsulated by the shell refers to a particle comprising (i) at least a first material or materials that form the center of the particle (i.e., the core) and (ii) at least a second material or materials (i.e., the shell) that form a layer over at least a portion of the surface of the first material(s). It should be appreciated that the first material(s) that forms the core is different from the second material(s) that forms the shell. Further, the core-shell particles can have various shapes (or morphologies) and sizes. For example, the core-shell particles can have generally spherical, cubic, platy, polyhedral, or acicular (elongated or fibrous) morphologies. The core-shell particles can also have an average particle size of from 30 to 300 nanometers, or from 40 to 200 nanometers, or from 50 to 150 nanometers. As used herein, “average particle size” refers to volume average particle size. The average particle size can for example be determined with a Zetasize 3000HS following the instructions in the Zetasize 3000HS manual.

As indicated, the core-shell particles comprise a polymeric core as well as a polymeric shell. A “polymeric core” means that the core of the core-shell particle comprises one or more polymers and a “polymeric shell” means that the shell of the core-shell particle comprises one or more polymers.

The polymeric shell of the core-shell particles can be obtained from components comprising hydroxyl functional ethylenically unsaturated compound(s), additional polyols such as polytetrahydrofuran, compounds containing one or more carboxylic acid groups, anhydrides such as trimellitic anhydride, polyisocyanates, and/or combinations thereof. The resulting polymeric shell prepared from the previously described components can comprise at least urethane linkages and hydroxyl and carboxylic acid functional groups. The resulting polymeric shell can also comprise ester linkages and/or ether linkages as well as additional functional groups.

Other non-limiting examples of reactive functional groups that can be formed on the polymeric shell and/or polymeric core include amine groups, epoxide groups, thiol groups, carbamate groups, amide groups, urea groups, isocyanate groups (including blocked isocyanate groups), ethylenically unsaturated groups, and combinations thereof. As used herein, “ethylenically unsaturated” refers to a group having at least one carbon-carbon double bond. Non-limiting examples of ethylenically unsaturated groups include, but are not limited to, (meth)acrylate groups, vinyl groups, and combinations thereof.

As previously described, the core-shell particles of the present invention include a polymeric core that is at least partially encapsulated by the polymeric shell. The polymeric core may for example comprise at least an addition polymer (i.e., a polymer formed from the linking of monomers without the co-generation of other by-products). The addition polymer of the polymeric core may be obtained by polymerization (e.g., by emulsion polymerization) of one or more ethylenically unsaturated monomers.

The ethylenically unsaturated monomers can comprise multi-ethylenically unsaturated monomers, mono-ethylenically unsaturated monomers, or combinations thereof. A “mono-ethylenically unsaturated monomer” refers to a monomer comprising only one ethylenically unsaturated group, and a “multi-ethylenically unsaturated monomer” refers to a monomer comprising two or more ethylenically unsaturated groups. Non-limiting examples of ethylenically unsaturated monomers include, but are not limited to, alkyl esters of (meth)acrylic acid, hydroxyalkyl esters of (meth)acrylic acid, acid group containing unsaturated monomers, vinyl aromatic monomers, and combinations thereof.

Non-limiting examples of alkyl esters of (meth)acrylic acid include methyl (meth)acrylate, ethyl (meth)acrylate, butyl (meth)acrylate, isobutyl (meth)acrylate, ethylhexyl (meth)acrylate, lauryl (meth)acrylate, octyl (meth)acrylate, glycidyl (meth)acrylate, isononyl (meth)acrylate, isodecyl (meth)acrylate, vinyl (meth)acrylate, acetoacetoxyethyl (meth)acrylate, acetoacetoxypropyl (meth)acrylate, and combinations thereof. Other non-limiting examples include di(meth)acrylate alkyl diesters.

Non-limiting examples of hydroxyalkyl esters of (meth)acrylic acid include hydroxymethyl (meth)acrylate, hydroxyethyl (meth)acrylate, hydroxypropyl (meth)acrylate, hydroxybutyl (meth)acrylate, and combinations thereof.

Non-limiting examples of acid group containing unsaturated monomers include (meth)acrylic acid, itaconic acid, maleic acid, fumaric acid, crotonic acid, aspartic acid, malic acid, mercaptosuccinic acid, and combinations thereof.

Non-limiting examples of vinyl aromatic monomers include styrene, 2,4-dimethyl styrene, ethyl styrene, isopropyl styrene, butyl styrene, vinyl naphthalene, vinyl toluene, divinyl aromatic monomers such as divinyl benzene, and combinations thereof.

The polymeric shell may be covalently bonded to at least a portion of the polymeric core. For example, the polymeric shell can be covalently bonded to the polymeric core by reacting at least one functional group on the monomers and/or prepolymers that are used to form the polymeric shell with at least one functional group on the monomers and/or prepolymers that are used to form the polymeric core. The functional groups can include any of the functional groups previously described provided that at least one functional group on the monomers and/or prepolymers that are used to form the polymeric shell is reactive with at least one functional group on the monomers and/or prepolymers that are used to form the polymeric core. For instance, the monomers and/or prepolymers that are used to form the polymeric shell and polymeric core can both comprise at least one ethylenically unsaturated group that are reacted with each other to form a chemical bond. As used herein, a “prepolymer” refers to a polymer precursor capable of further reactions or polymerization by one or more reactive groups to form a higher molecular mass or cross-linked state.

The polymeric core and polymeric shell of the core-shell particles are also prepared to provide a hydrophilic polymeric shell with enhanced water-dispersibility/stability and a hydrophobic polymeric core. As used herein, the term “hydrophilic” refers to polymers, monomers, and other materials that have an affinity for water and which will disperse or dissolve in water or other aqueous mediums. Hydrophilic materials, such as hydrophilic polymers, typically have water-dispersible groups. A “water-dispersible group” refers to a group having or formed from one or more hydrophilic functional groups that have an affinity for water and which help disperse a compound, such as a polymer, in water or other aqueous mediums. Further, as used herein, the term “hydrophobic” refers to polymers, monomers, and other materials that lack an affinity for water or other aqueous mediums and tend to repel, not dissolve or disperse in, and/or not be wetted by water or other aqueous mediums. Hydrophobic materials, such as hydrophobic polymers, are often free of water-dispersible groups.

As indicated, the polymeric core and polymeric shell of the core-shell particles can be prepared to provide a hydrophilic polymeric shell with enhanced water-dispersibility/stability and a hydrophobic polymeric core. Thus, the polymeric shell can comprise hydrophilic water-dispersible groups while the polymeric core can be free of hydrophilic water-dispersible groups. The hydrophilic water-dispersible groups can increase the water-dispersibility/stability of the polymeric shell in an aqueous medium so that the polymeric shell at least partially encapsulates the hydrophobic core.

As previously described, the water-dispersible groups comprise one or more hydrophilic functional groups. For example, the polymer(s) that form the hydrophilic polymeric shell can comprise ionic or ionizable groups such as carboxylic acid functional groups or salts thereof. The carboxylic acid functional groups can be at least partially neutralized (i.e., at least 30% of the total neutralization equivalent) by a base, such as a volatile amine, to form a salt group. A volatile amine refers as an amine compound having an initial boiling point of less than or equal to 250° C. as measured at a standard atmospheric pressure of 101.3 kPa. Examples of suitable volatile amines are ammonia, dimethylamine, trimethylamine, monoethanolamine, and dimethylethanolamine. It should be appreciated that the amines will evaporate during the formation of the coating layer to expose the carboxylic acid functional groups and allow the carboxylic acid functional groups to undergo further reactions. Other non-limiting examples of water-dispersible groups include polyoxyalkylene groups such as by using polyethylene/propylene glycol ether materials for example.

As indicated, the film-forming resin can also comprise a self-emulsifying dispersion polymer. As used herein, a self-emulsifying dispersion polymer refers to a polymer that contains hydrophilic functionality and is not synthesized initially as an aqueous dispersion, and then mixed with water to form an aqueous dispersion. The self-emulsifying dispersion polymer therefore does not form a core-shell particle.

The self-emulsifying dispersion polymer of the present invention can be selected from various types of polymers provided that they are self-emulsifying. For instance, the self-emulsifying dispersion polymer can be selected from polyurethanes, polyesters such as polyester polyols, polyamides, polyethers, polysiloxanes, fluoropolymers, polysulfides, polythioethers, polyureas, (meth)acrylic resins, epoxy resins, vinyl resins, and combinations thereof. The self-emulsifying dispersion polymer can also be obtained from the previously described components comprising hydroxyl functional ethylenically unsaturated compound(s), additional polyols such as polytetrahydrofuran, compounds containing one or more carboxylic acid groups, anhydrides such as trimellitic anhydride, polyisocyanates, and/or combinations thereof.

As indicated, the film-forming resin can comprise both the previously described polymeric core-shell particles and the self-emulsifying dispersion polymer. When the coating composition of the present invention comprises both the polymeric core-shell particles and the self-emulsifying dispersion polymer, the coating composition can comprise a greater amount of the polymeric core-shell particles than the self-emulsifying dispersion polymer or a greater amount of the self-emulsifying dispersion polymer than the polymeric core-shell particles.

The coating composition can include at least 10 weight %, at least 20 weight %, or at least 30 weight % of the film-forming resin, based on the total solids weight of the coating composition. The coating composition can include up to 99 weight %, up to 95 weight %, or up to 90 weight % of the film-forming resin, based on the total solids weight of the coating composition. The coating composition can include an amount of from 10 weight % to 99 weight %, or from 20 weight % to 95 weight %, or from 30 weight % to 90 weight % of the film-forming resin, based on the total solids weight of the coating composition. As used herein, the term “total solids” or “solids” refers to the solids content as determined in accordance with ASTM D2369 (2015).

As previously noted, the film-forming resin is dispersed in an aqueous medium. As used herein, an “aqueous medium” refers to a liquid medium comprising at least 50 weight % water, based on the total weight of the liquid medium. Such aqueous liquid mediums can for example comprise at least 60 weight % water, or at least 70 weight % water, or at least 80 weight % water, or at least 90 weight % water, or at least 95 weight % water, or 100 weight % water, based on the total weight of the liquid medium. The solvents that, if present, make up less than 50 weight % of the liquid medium include organic solvents. Non-limiting examples of suitable organic solvents include polar organic solvents, e.g. protic organic solvents such as glycols, glycol ether alcohols, alcohols, volatile ketones, glycol diethers, esters, and diesters. Other non-limiting examples of organic solvents include aromatic and aliphatic hydrocarbons.

The coating composition of the present invention may also include a swelling solvent that swells the film-forming resin. As used herein, a “swelling solvent” refers to a solvent that interacts with the film-forming resin causing it to swell and expand. The swelling solvent used with the coating composition of the present invention may be an organic solvent. Non-limiting examples of suitable organic solvents used as a swelling solvent include alcohols and glycol ethers, such as propylene glycol monobutyl ether, ethylene glycol monohexyl ether, ethylene glycol monobutyl ether, ethylene glycol 2-ethylhexyl ether, propylene glycol monophenyl ether, n-butoxypropanol, 2,2,4-trimethylpentane-1,3-diol monoisobutyrate, n-butanol, n-hexanol, benzyl alcohol, 2-ethylhexanol and 1-octanol. The swelling solvent can be included as a component of the aqueous medium as previously described. The swelling solvent used with the present invention can cause the low shear viscosity of the film-forming resin dispersion to increase by at least 20%, or at least 50%, or at least 100%, or at least 500%, when added to the film-forming resin dispersion at 10 weight % based on resin solids.

The coating composition may also comprise one or more crosslinkers that are reactive with at least the film-forming resin. As used herein, a “crosslinking agent”, “crosslinker”, and like terms refers to a molecule comprising two or more functional groups that are reactive with other functional groups and which is capable of linking two or more monomers or polymer molecules through chemical bonds. Non-limiting examples of crosslinkers include aminoplasts such as melamine-formaldehyde resins, carbodiimides, polyols, phenolic resins, epoxy resins, beta-hydroxy (alkyl) amide resins, hydroxy (alkyl) urea resins, oxazoline, alkylated carbamate resins, (meth)acrylates, isocyanates, blocked isocyanates, polyacids, anhydrides, organometallic acid-functional materials, polyamines, polyamides, aziridines, and combinations thereof.

The coating composition can include at least 2 weight %, at least 10 weight %, or at least 20 weight % of the crosslinker, based on the total solids weight of the coating composition. The coating composition can include up to 60 weight %, up to 50 weight %, or up to 40 weight % of the crosslinker, based on the total solids weight of the coating composition. The coating composition can include from 2 weight % to 60 weight %, or from 10 weight % to 50 weight %, or from 20 weight % to 40 weight % of the crosslinker, based on the total solids weight of the coating composition.

The coating composition may also comprise a rheology modifier. As used herein, a “rheology modifier” refers to a component that adjusts flow behavior of a composition by increasing the viscosity of the composition. The rheology modifier used in the coating composition may increase the viscosity and adjust the flow behavior of the coating composition. Non-limiting examples of rheology modifiers include alkali swellable polymers that are optionally combined with a wax.

As used herein, an “alkali swellable polymer” refers to a polymer, such as an emulsion polymer, that incorporates water in an alkaline liquid medium to form a gel and adjust the viscosity. The polymer, when introduced to the solution, imparts little or no viscosity change, but upon adjusting the pH to mildly acidic, neutral, or mildly basic conditions, a measurable increase in viscosity is observed, i.e., adding an alkali agent to a solution containing an alkali swellable polymer results in the development of a viscosity change.

Non-limiting examples of alkali swellable polymers include, but are not limited to, high molecular weight crosslinked polyacrylic polymers and copolymers (e.g., copolymers have substitution of some of the acrylic acid with alkylmethacrylates), including acidic polymers and partially neutralized polymers. The alkali swellable polymer may be a high molecular weight crosslinked acidic polyacrylic polymer or copolymer, where the crosslinking may include polymers of acrylic acid crosslinked with allyl sucrose or allyl pentaerythritol or crosslinked with both allyl sucrose and allyl pentaerythritol, or polymers of acrylic acid and C₁₀-C₃₀ alkyl acrylate crosslinked with allyl pentaerythritol. The polymer or copolymer may contain a block copolymer of polyethylene glycol and a long chain alkyl acid ester. The alkali meltable polymer may be a homopolymer of 2-propenoic acid (acrylic acid) crosslinked with polyalkenyl polyether, for example polymer allyl sucrose. Copolymers of acrylic acid with acrylic acid esters of methacrylate esters such that the product retains its alkali-swellable properties are also contemplated. Incorporation of other monomers into the polymer chain to improve, for example, ion tolerance while still retaining alkali swellable properties, may also provide a suitable alkali swellable polymer. Representative trade names illustrative of the types of polymers useful as alkali swellable polymers include CARBOPOL, CARBOPOL EL, and CARBOPOL ETD series of products and the PEMULEN polymers also from Lubrizol Inc. (Wickliffe, Ohio), and the FLOGEL polymer series from SNF Inc. (Riceboro, Ga.).

The alkali swellable polymer may include an alkali swellable acrylic emulsion (ASE), which refers to an acrylic emulsion copolymer that is straight chain Or crosslinked and contains acid groups. The ASE may not comprise hydrophobic modification. The ASE may be selected from homopolymers of (meth)acrylic acid, and copolymers of (meth)acrylic acid, (meth)acrylate esters and maleic acid. When the pendant carboxylic groups are neutralized with art alkaline agent, the polymer is said to swell or its backbone expands, producing considerable viscosity increase and rheology modification which thickens the liquid phase in which the ASE is present effectively at pH values of at least 6 because the ASE may be water insoluble at pH values of less than 6 and water soluble at pH values dal least 6. Alkali soluble or alkali swellable emulsion thickeners that contain no hydrophobic groups and thicken by a non-associative mechanism upon neutralization with base are described in the an as ASE thickeners. As a general rule, a higher molecular weight ASEs will give greater efficiencies.

The ASE may be made up chemically of one to two blocks as represented by:

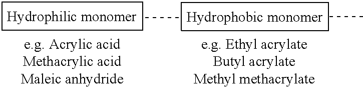

Suitable hydrophilic monomers for the ASE include, but are not limited to acrylic acid, methacrylic acid, maleic acid, and/or combinations thereof. Suitable hydrophobic monomers for the ASE may include the esters of acrylic or methacrylic acid with C1- to C4-alcohols, such as ethyl acrylate, butyl acrylate and methyl methacrylate.

An example for an ASE structure is shown in Formula (1)

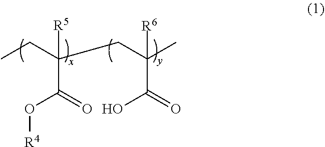

wherein R4 is C1 to C4 alkyl; R5, R6 are independently hydrogen or methyl; x and y are stoichiometric indices that allow that the respective monomer units are present in an amount of 10 to 90 weight percent each, and that the molecular weight of the ASE structure is between 1,000 and 2,000,000 g/mol. For example, R4 is ethyl or butyl and R5 is hydrogen. For example, R4 is methyl and R5 is methyl. For example, R6 is methyl.

Ile alkali swellable polymer may include a hydrophobically modified alkali swellable acrylic emulsion (HASE), which refers to an acrylic emulsion copolymer which is straight chain or crosslinked and contains acid groups and hydrophobic pendent groups. The HASE thickens primarily by pendant carboxylic acid group neutralization with an alkaline agent and at least partially by an associative mechanism, as is described, in the art for HASE thickeners. The stiffness caused by steric hindrance of the polymer backbone and the hydrophobicity of the pendant groups are responsible for the rheological changes in the liquid phase containing HASE. As a general rule an increase in the hydrophobe chain length or the number of hydrophobes per unit of polymer will give greater viscosifying efficiencies.

The HASE may be made up chemically of three blocks as represented by:

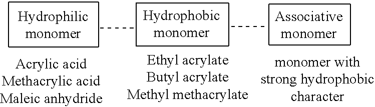

The hydrophilic and hydrophobic monomers suitable for the HASE may be the same as described with respect to the ASE. The associative monomer of the HASE may be a monomer that shows a strong hydrophobic character, such examples including an ester of acrylic acid or methacrylic acid with C8-C22 alcohols, such as C12-C20 alcohols.

An example for a HASE structure is shown in Formula (2)

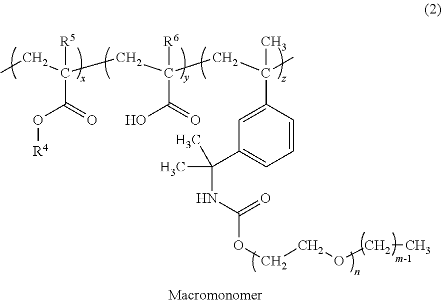

In Formula (2), RA is C1 to C4 alkyl; R5, R6 are independently hydrogen or methyl; n is a number from 1 to 20; m is a number from 2 to 5; x, y, z are stoichiometric indices that allow that the HASE of Formula (2) to include 10 to 89 weight percent of the “x” monomer, 10 to 89 weight percent of the “y” monomer and 0.01 to 1 weight percent of the Macromonomer, and that the EASE structure of Formula (2) has a molecular weight of 1,000 to 2,000,000 g/mol.

Another example for a HASE structure is shown in Formula (3)

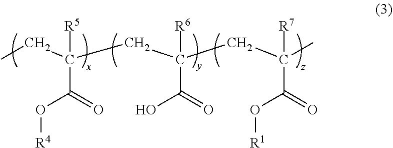

wherein R4, R5, R6, x, y, z have the meaning as given for Formula (2) R1 is C8 to C22, such as C12 to C20 alkyl or alkenyl; R7 is hydrogen or methyl.

The alkali swellable polymer may include a hydrophobically modified ethylene oxide urethane (HELM), which refers to a nonionic hydrophilic polymer, which may be formed by reaction of diisocyanates with diols and hydrophobic capping or blocking groups. The HEUR may be purely an associative thickener that develop intra- or intermolecular links as their hydrophobic groups associate with other hydrophobic ingredients in the formulation. The strength of the association may depend on the number, size, and frequency of the hydrophobic capping or blocking units. The HEUR may develop micelles as would a normal surfactant, which micelles may link between the other ingredients by associating with their surfaces to build a three dimensional network.

As indicated, the alkali swellable polymers can optionally be combined with a wax. The wax may, at temperatures from 40° C. to 100° C., change state into that of a low-viscosity molten liquid. The wax may form drops on melting and may not form filaments as is the case for other polymers.

Non-limiting examples of suitable waxes may include, but are not limited to, natural waxes and synthetic waxes. Natural waxes may include, but are not limited to, mineral waxes, vegetable waxes, animal waxes, and/or mixtures thereof. Non-limiting examples include, but are not limited to, crude montan wax, fully refined wax, microcrystalline wax, vaseline, carnauba wax, candelilla wax, beeswax and shellac wax. Non-limiting examples of synthetic waxes include, but are not limited to, Fischer-Tropsch synthesis paraffin, oxidized Fischer-Tropsch paraffin, polyethylene wax, polypropylene wax and oxidized derivatives thereof, polycaprolactone s silicone waxes, wax, alcohols, polyethylene-vinyl acetate copolymers, polyethylene-acrylic acid copolymers, polyglycol waxes and V-Wachs (polyvinyl ether).

The coating composition can include 20 weight % or less or 18 weight % or less of the rheology modifier, based on the total weight of the coating composition. The coating composition can include at least 5 weight %, such as at least 7 weight %, at least 9 weight %, at least 10 weight %, or at least 12 weight % of the rheology modifier, based on the total weight of the coating composition. The coating composition can include from 5 weight % to 20 weight %, from 7 weight % to 20 weight %, from 9 weight % to 20 weight %, from 5 weight % to 18 weight %, from 7 weight % to 18 weight %, or from 9 weight % to 18 weight % of the rheology modifier, based on the total weight of the coating composition.

The coating composition may further comprise at least one colorant, such as a black colorant for example. As used herein, a “colorant” refers to any substance that imparts color and/or other opacity and/or other visual effect to the composition. The colorant can be added to the coating composition in any suitable form, such as discrete particles, dispersions, solutions, and/or flakes. A single colorant or a mixture of two or more colorants can be used in the coatings of the present invention.

Example colorants include pigments (organic or inorganic), dyes and tints, such as those used in the paint industry and/or listed in the Dry Color Manufacturers Association (DCMA), as well as special effect compositions. A colorant may include, for example, a finely divided solid powder that is insoluble, but wettable, under the conditions of use. A colorant can be organic or inorganic and can be agglomerated or non-agglomerated. Colorants can be incorporated into the coatings for example by, use of a grind vehicle, such as an acrylic grind vehicle, the use of which will be familiar to one skilled in the art.

Example pigments and/or pigment compositions include, but are not limited to, carbazole dioxazine crude pigment, azo, monoazo, diazo, naphthol AS, benzimidazolone, isoindolinone, isoindoline and polycyclic phthalocyanine, quinacridone, perylene, perinone, diketopyrrolo pyrrole, thioindigo, anthraquinone, indanthrone, anthrapyrimidine, flavanthrone, pyranthrone, anthanthrone, dioxazine, triarylcarbonium, quinophthalone pigments, diketo pyrrolo pyrrole red (“DPPBO red”), titanium dioxide, carbon black, and/or mixtures thereof.

Example dyes include, brat are not limited to, those that are solvent and/or aqueous based such as phthalol green or blue, iron oxide, bismuth vanadate, anthraquinone, and perylene and quinacridone.

Example tints include, but are not limited to, pigments dispersed in water-based or water miscible carriers such as AQUA-CHEM 896 commercially available from Evonik and CHARISMA COLORANTS and MAXITONER INDUSTRIAL COLORANTS commercially available from Accurate Dispersions.

The coating composition can also comprise additional materials including, but not limited to, additional resins such as additional film-forming resins. The additional resin can include any of a variety of thermoplastic and/or thermosetting film-forming resins known in the art. The term “thermosetting” refers to resins that “set” irreversibly upon curing or crosslinking, wherein the polymer chains of the resins are joined together by covalent bonds. Once cured or crosslinked, a thermosetting resin will not melt upon the application of heat and is insoluble in solvents. As noted, the film-forming resin can also include a thermoplastic film-forming resin. The term “thermoplastic” refers to resins that are not joined by covalent bonds and, thereby, can undergo liquid flow upon heating and can be soluble in certain solvents.

Non-limiting examples of suitable additional resins include (meth acrylic resins, polyesters such as polyester polyols, polyurethanes, polyamides, polyethers, polysiloxanes, fluoropolymers, polysulfides, polythioethers, polyureas, epoxy resins, vinyl resins, and combinations thereof. The additional resins can also include particulate and non-particulate resins.

The additional resin can have any of a variety of reactive functional groups including, but not limited to, carboxylic acid groups, amine groups, epoxide groups, hydroxyl groups, thiol groups, carbamate groups, amide groups, urea groups, isocyanate groups (including blocked isocyanate groups), (meth)acrylate groups, and combinations thereof. Thermosetting coating compositions typically comprise a crosslinker that may be selected from any of the crosslinkers known in the art to react with the functionality of the resins used in the coating compositions. The crosslinkers can include any of those previously described. Alternatively, a thermosetting film-forming resin can be used having functional groups that are active with themselves; in this manner, such thermosetting resins are self-crosslinking.

Other non-limiting examples of components that can be used with the coating compositions of the present invention include plasticizers, abrasion resistant particles, fillers including, but not limited to, micas, talc, clays, and inorganic minerals, metal oxides, metal flake, various forms of carbon, anti-oxidants, hindered amine light stabilizers, UV light absorbers and stabilizers, surfactants, flow and surface control agents, thixotropic agents, reactive diluents, catalysts, reaction inhibitors, corrosion-inhibitors, and other customary auxiliaries.

The coating composition can be formed to a have a low solids content. For example, the coating composition can have a solids content of less than 25 weight %, or less than 20 weight or less than 15 weight %, based on the total weight of the coating composition. The coating composition can also have a solids content of at least 5 weight % or at least 8 weight %, based on the total weight of the coating composition. The solids content of the coating composition can range from 5 weight % to 25 weight % or from 8 weight % to 12 weight %, based on the total weight of the coating composition. This low solids content is believed to contribute, at least in part, to the coating composition being suitable for application with precision application devices that can apply the coating composition without overspray.

The coating composition can also exhibit a particular rheology profile. For instance, the coating composition can have a high-shear viscosity of from 60 to 110 mPa·s, such as 60 to 100 mPa·s, at shear rate of 1000 s⁻¹, and/or a low-shear viscosity of from 3 to 32 Pa·s, such as from 3 to 30 or from 3 to 25 or from 3 to 20 or from 5 to 18 or from 7 to 15 Pa·s, at shear rate of 0.1 s⁻¹. The viscosity is determined according to ASTM 2196-15 Method B Spindle No LV-1. This rheology profile is believed to contribute, at least in part, to the coating composition being suitable for application with precision application devices that can apply the coating composition without overspray.

The coating composition may be applied over a substrate positioned substantially horizontal relative to the ground. As used herein, a substrate positioned “substantially horizontal relative to the ground” refers to a substrate having at least a portion of the surface being coated being parallel to or within 10°, such as within 5°, of being parallel to the ground. The coating composition applied over the substrate positioned substantially horizontal relative to the ground may have a high-shear viscosity of from 60 to 100 mPa·s at shear rate of 1000 s⁻¹, and/or a low-shear viscosity of from 3 to 20 Pa·s, such as from 5 to 15 Pa·s, at shear rate of 0.1 s⁻¹.

The coating composition may be applied over a substrate positioned substantially vertical relative to the ground. As used herein, a substrate positioned “substantially vertical relative to the ground” refers to a substrate having at least a portion of the surface being coated being perpendicular to or within 45°, such, as within 40°, within 30°, within 20°, within 10°, or within 5°, of being perpendicular to the ground. The coating composition applied over the substrate positioned substantially vertical relative to the ground may have a high-shear viscosity, of from 60 to 110 mPa·s, such as from 60 to 100 mPa·s, at shear rate of 1000 s and/or a low-shear viscosity of from 15 to 32 Pa·s, such as from 17 to 25 Pa·s, at shear rate of 0.1 s⁻¹.

The coating composition may have a surface tension such that the difference in the surface tension of the surface of the substrate coated with a clear topcoat and the surface tension of the coating composition applied over the substrate (surface tension (clear coated substrate) surface tension (coating composition)) is greater than 0, such as greater than 0.5, greater than 0.7, greater than 1, greater than 2. Surface tension of the coating composition is determined according to DIN EN 14370:2004-11 (Surface active agents—Determination of surface tension; German version EN 14370:2004;2004-11), and the surface tension of the surface of the substrate is determined according to DIN EN ISO 19403-2:2020-04 (Wettability—Part 2: Determination of the surface free energy of solid surfaces by measuring the contact angle (ISO 19403-1:2017); German version EN ISO 19403-2:2020; 2020-04). This difference in surface tensions is believed to contribute, at least in part, to the coating composition being suitable for application with precision application devices that can apply the coating composition without overspray.

The coating composition of the present invention can be applied over at least a portion of a substrate to firm a coating layer such as a basecoat layer. A “basecoat layer” refers to a coating layer that is applied onto a primer, another basecoat layer, and/or directly onto a substrate, optionally including components (such as pigments) that impact the color and/or provide other visual impact.

The substrate over which the coating composition may be applied includes a wide range of substrates. For example, the coating composition of the present invention can be applied to a vehicle substrate, an industrial substrate, an aerospace substrate, and the like.

The vehicle substrate may include a component of a vehicle. In the present disclosure, the term “vehicle” is used in its broadest sense and includes all types of aircraft, spacecraft, watercraft, and ground vehicles. For example, the vehicle can include, but is not limited to an aerospace substrate (a component of an aerospace vehicle, such as an aircraft such as, for example, airplanes (e.g., private airplanes, and small, medium, or large commercial passenger, freight, and military airplanes), helicopters (e.g., private, commercial, and military helicopters), aerospace vehicles (e.g., rockets and other spacecraft), and the like). The vehicle can also include a ground vehicle such as, for example, animal trailers (e.g., horse trailers), cars, trucks, buses, vans, heavy duty equipment, golf carts, motorcycles, bicycles, trains, railroad cars, and the like. The vehicle can also include watercraft such as, for example, ships, boats, hovercrafts, and the like. The vehicle substrate may include a component of the body of the vehicle, such as an automotive hood, door, trunk, roof, and the like; such as an aircraft or spacecraft wing, fuselage, and the like; such as a watercraft hull, and the like.

The coating composition may be applied over an industrial substrate which may include tools, heavy duty equipment, furniture such as office furniture (e.g., office chairs, desks, filing cabinets, and the like), appliances such as refrigerators, ovens and ranges, dishwashers, microwaves, washing machines, dryers, small appliances (e.g., coffee makers, slow cookers, pressure cookers, blenders, etc.), metallic hardware, extruded metal such as extruded aluminum used in window framing, other indoor and outdoor metallic building materials, and the like.

The coating composition may be applied over storage tanks, windmills, nuclear plants, packaging substrates, wood flooring and furniture, apparel, electronics, including housings and circuit boards, glass and transparencies, sports equipment, including golf balls, stadiums, buildings, bridges, and the like.

The substrate may be a metallic or non-metallic component. Metallic substrates include, but are not limited to, tin, steel (including electrogalvanized steel, cold rolled steel, hot-dipped galvanized steel, steel alloys, or blasted/profiled steel, among others), aluminum, aluminum alloys, zinc-aluminum alloys, steel coated with a zinc-aluminum alloy, and aluminum plated steel. As used herein, blasted or profiled steel refers to steel that has been subjected to abrasive blasting and which involves mechanical cleaning by continuously impacting the steel substrate with abrasive particles at high velocities using compressed air or by centrifugal impellers. The abrasives are typically recycled/reused materials and the process can efficiently remove mill scale and rust. The standard grades of cleanliness for abrasive blast cleaning is conducted in accordance with BS EN′ ISO 8501-1.

Further, non-metallic substrates include polymeric substrates, such, as polyester, polyolefin, polyamide, cellulosic, polystyrene, polyacrylic, polyethylene naphthalate), polypropylene, polyethylene, nylon, ethylene vinyl alcohol (EVOH), polylactic acid (PLA), other “green” polymeric substrates, poly(ethylene terephthalate) (PET), polycarbonate, polycarbonate acrylobutadiene styrene (PC/ABS), polyamide, and/or plastic composite substrates such as glass or carbon fiber composites. The non-metallic substrates may include wood, veneer, wood composite, particle board, medium density fiberboard, cement, stone, glass, paper, cardboard, textiles, leather both synthetic and natural, and the like.

The coating composition of the present invention may be particularly beneficial when applied to a metallic substrate. For example, the coatings of the present invention may be particularly beneficial when applied to metallic substrates that are used to fabricate vehicles, such as automotive vehicles, such as cars, trucks, and tractors.

The coating composition can be applied over at least a portion of the substrate or another coating layer by any means, such as spraying, electrostatic spraying, dipping, rolling, brushing, and the like. The coating composition can also be applied with precision application devices that can apply the coating composition without any overspray. Such devices can therefore apply the coating composition of the present invention over a substrate that is not masked with a removable material (such as taping materials for example). The chemistry of the coating composition of the present invention used in combination with the precision application devices may enable the coating composition to be applied over at least a portion of the substrate without overspray.

It should be appreciated that precision application devices that apply coating compositions without overspray can be used to produce a desired pattern and/or design over the substrate. For example, these application devices can apply coating compositions in a single pass without masking the substrate to produce two or more colors over different portions of the substrate.

Non-limiting examples of devices that can apply coating compositions without overspray include devices that apply compositions as a continuous jet, as continuous droplets, and/or as a drop on-demand. Specific non-limiting examples of such devices include continuous inkjet printers, gas-ejection droplet generators, vibrating tip droplet generators, piezo-actuated micropneumatic droplet generators, and electrohydrodynamic droplet generators.

Once applied, the coating composition of the present invention can be dehydrated to form the coating layer. The coating composition can be dehydrated at ambient temperatures (e.g. 20° C., to 25° C.) to 90° C., or from ambient temperatures to 80° C., or from ambient temperatures to 70° C., or from ambient temperatures to 60° C., or from 40° C. to 80° C. or from 40° C. to 70° C. The coating composition can also be cured at temperatures of less than 120° C., or less than 100° C., or less than 80° C.

The coating compositions of the present invention can be applied and cured over the substrate to form various dry film thicknesses including a low dry film thickness of 20 microns or less, or 18 microns or less, or 15 microns or less.

The coating composition of the present invention can be formed with a low solids content and/or a rheology profile as previously described that allows the composition to be applied with precision application devices that prevent overspray. The coating composition can provide desirable coating properties including good hiding properties such as desired in black colored coatings, low sagging, good leveling, and the like.

The coatings of the present invention can be formed at lower dehydration/cure temperatures than those typically required in other Coatings commonly applied to automotive substrates. As such, the coatings of the present invention, including the multi-layer coatings further described herein, help reduce costs and speed up the overall coating process.

The coating composition of present invention can be applied with additional compositions to form a multi-layer coating system that comprises at least a first basecoat layer and a second basecoat layer. The multi-layer coating can include additional coating layers including, but not limited to, a primer layer, an additional basecoat layer(s), a topcoat layer, or a combination thereof. A “primer coating layer” refers to an undercoating layer that may be applied onto a substrate in order to prepare the surface for application of a protective or decorative coating system, and a “topcoat” refers to an uppermost coating layer that is applied over another coating layer such as a basecoat to provide a protective and/or decorative layer.

The first basecoat layer and/or the second basecoat layer of the multi-layer coating system may be formed from the previously described coating composition. The coating compositions used to form the first and second basecoat layers can be the same or different. For instance, the first and second basecoat layers can each be formed from the previously described coating composition. Alternatively, one of the first or second basecoat layers can be formed with a diff rem coating, composition, such as the later described low temperature cure coating composition.

The first basecoat composition can be applied directly over at least a portion of the substrate and/or a primer layer followed by the second basecoat composition as a wet-on-wet process, (i.e. prior to dehydration of the first basecoat composition). After the second basecoat composition is applied, both basecoat compositions can be dehydrated simultaneously. Both basecoat compositions can be dehydrated simultaneously at ambient temperatures (e.g. 20° C. to 25° C.) to 90° C., or from ambient temperatures to 80° C., or from ambient temperatures to 70° C. or from ambient temperatures to 60° C., or from 40° C. tip 80° C., or from 40″C to 70° C.

The second basecoat composition can also be applied directly over at least a portion of the first basecoat layer that has been dehydrated as previously described. The second basecoat composition can then be dehydrated at ambient temperatures (e.g. 20° C. to 25° C.) to 90° C., or from ambient temperatures to 80° C., or from ambient temperatures to 70° C., or from ambient temperatures to 60° C., or from 40° C. to 80° C., or from 40° C. to 70° C. After the dehydrating the second basecoat composition, the basecoats can be cured at temperatures of less than 120° C., or less than 100° C., or less than 80° C.

The multi-layer coating system can also comprise a topcoat, layer that is applied over least a portion of the second basecoat layer before or after curing the basecoat layers. The topcoat layer can optionally be formed from a coating composition that comprises a film-forming resin, a crosslinker, an aqueous or organic solvent medium, and/or any of the other materials such as those previously described. For example, the topcoat can comprise a film-forming resin and a polyisocyanate such as an uretdione dimer based polyisocyanate that is reactive with the film-forming resin.

The topcoat layer optionally used with the multi-layer coating system of the present invention can be a clear topcoat layer. As used herein, a “clear coating layer” refers to a coating layer that is at least substantially transparent or fully transparent. The term “substantially transparent” refers to a coating, wherein a surface beyond the coating layer is at least partially visible to the naked eye when viewed through the coating. The term “fully transparent” refers to a coating, wherein a surface beyond the coating layer is completely visible to the naked eye when viewed through the coating. It should be appreciated that the clear topcoat layer can comprise colorants, such as pigments, provided that the colorants do not interfere with the desired transparency of the clear topcoat layer. Alternatively, the clear topcoat layer is free of colorants such as pigments (i.e., unpigmented).

As indicated, the topcoat layer can be cured simultaneously with the first and second basecoat layers. For instance, the topcoat layer and basecoat layers can be simultaneously cured at temperatures of less than 120° C., or less than 100° C., or less than 80° C.

The multi-layer coating system according to the present invention can also comprise other optional layers including, but not limited to, additional basecoat layers (e.g., a third basecoat layer over the second basecoat layer) as well as a primer coating layer as indicated above. The primer coating layer can be formed over at least a portion of the substrate and the first or second basecoat layer can be formed over at least a portion of the primer coating layer.

The multi-layer coating system may include a first basecoat layer positioned over at least a portion of the substrate and a second basecoat layer positioned over at least a portion of the first basecoat layer, so as to form a substrate coated with a multi-layer coating system. The first basecoat layer may be formed from a low temperature cure coating composition different from the previously described coating composition. The second basecoat layer may be formed from the previously described coating composition, including a film-forming resin dispersed in an aqueous medium, a crosslinker reactive with the film-forming resin, and a colorant, wherein the solids content thereof is less than 25 weight %, based on the total weight of the coating composition. The second basecoat composition may include a rheology modifier and/or a swelling solvent that swells the film-forming resin. The first basecoat composition and the second basecoat composition may be dehydrated and/or cured simultaneously or separately as previously described and at the temperatures described herein. The second basecoat composition may be applied over the first basecoat layer after the first basecoat composition has been dehydrated and/or cured, such that second basecoat composition is applied over a hard-coated substrate. The second basecoat layer may be in direct contact with the first basecoat layer.

The multi-layer coating system may include a first basecoat layer positioned over at least a portion of the substrate and a second basecoat layer positioned over at least a portion of the first basecoat layer and a third basecoat layer positioned over at least a portion of the second basecoat layer, so as to form a substrate coated with a multi-layer coating system. The first and second basecoat layers may be formed from a low temperature cure coating composition different from the previously described coating composition. The third basecoat layer may be formed from the previously described coating composition. The first basecoat composition and the second basecoat composition and the third basecoat composition may be dehydrated and/or cured simultaneously or separately as previously described and at the temperatures described herein. The third basecoat composition may be applied over the second basecoat layer after the second basecoat composition has been dehydrated and/or cured, such that the third basecoat composition is applied over a had-coated substrate. The third basecoat layer may be in direct contact with the first and/or the second basecoat layer.

The multi-layer coating system may include a first basecoat layer positioned over at least a portion of the substrate and a second basecoat layer positioned over at least a portion of the first basecoat layer and a topcoat layer positioned over at least a portion of the second basecoat layer, so as to form a substrate coated with a multi-layer coating system. The first and second basecoat layers may be formed from a low temperature cure coating composition different from the previously described coating composition. The topcoat layer may be formed from the previously described coating composition. The first basecoat composition and the second basecoat composition and the topcoat composition may be dehydrated and/or cured simultaneously or separately as previously described and at the temperatures described herein. The first basecoat composition and the second basecoat composition may be dehydrated simultaneously or separately, followed by application of the topcoat composition. The dehydrated first and second basecoat compositions and subsequently applied topcoat composition may be simultaneously cured. The topcoat composition may be applied over the second basecoat layer after the second basecoat composition has been dehydrated and/or cured, such that topcoat composition is applied over a hard-coated substrate. The topcoat layer maybe in direct contact with the first and/or the second basecoat layer.

The low temperature cure coating composition may be dehydrated and/or cured at relatively low temperatures. Dehydrating refers to removal of water from an applied coating composition (i.e., drying). Curing refers to the applied coating composition undergoing a crosslinking reaction. The applied low temperature cure coating composition may be dehydrated and subsequently cured.

The low temperature cure coating composition can be dehydrated at ambient temperatures (e.g. 20° C. to 25° C.) to 110° C., or from ambient temperatures to 100° C., or from ambient temperatures to 90° C., or from ambient temperatures to 80° C., or from ambient temperatures to 70° C., or from ambient temperatures to 60° C., or from ambient temperatures to 50° C., or from ambient temperatures to 40° C., or from 40° C. to 80° C., or from 40° C. to 70° C. The coating composition can be dehydrated using heat at temperatures of 140° C. or less, or 120° C. or less, or 100° C. or less, or 80° C. or less. The coating composition can be dehydrated at these temperatures for a period of time of 5 minutes or less, such as 4 minutes or less, 3 minutes or less, 2 minutes or less, or 1 minute or less. The period of time for dehydrating the coating composition is the designated period of time for dehydration and does not include the time it takes to transfer and subject the coating composition to another step, such as a curing step. The coating composition dehydrating at the above-referenced temperatures and/or times means that the coating composition achieves solids content of at least 75%, such as at least 80%, at least 85%, or at least 90% within the temperature and/or time conditions. The low temperature cure coating composition may include any composition capable of dehydrating under these conditions. Low temperature cure coating compositions may be desirable as a basecoat over which the previously described coating composition is directly applied due to its ability to dehydrate relatively quickly at relatively low temperatures.

The low temperature cure coating composition can be cured at ambient temperatures (e.g. 20° C. to 25° C.) to 110° C., or from ambient temperatures to 100° C., or from ambient temperatures to 90° C., or from ambient temperatures to 80° C., or from ambient temperatures to 70° C., or from ambient temperatures to 60° C., or from 40° C. to 80° C., or from 40° C. to 70° C. The coating composition can be cured using heat at temperatures of 140° C. or less, or 120° C. or less, or 100° C. or less, or 80° C. or less. The coating composition can be cured at these temperatures for a period of time of 30 minutes or less, such as 20 minutes or less, 15 minutes or less, 10 minutes or less, 5 minutes or less, 4 minutes or less, 3 minutes or less, 2 minutes or less, or 1 minute or less. The period of time for curing the coating composition is the designated period of time for cure and does not include the time it takes to transfer and subject the coating composition to another step. The low temperature cure coating composition may include any composition capable of curing under these conditions.

The low temperature cure coating composition, when cured to form a coating layer having a thickness of 35 μm by baking at 80° C. for 30 minutes, achieves 100 MEK double rubs as measured according to ASTM D5402-19.

Non-limiting examples of low temperature cure coating compositions include those coating compositions described in US 2016/0068706 ([0041]-[0086]); US 2019/0002709 ([0008]-[0065], [0128]-[0141]); WO 2017/160398 ([0007]-[0063], [0097]-[00131]); WO 2019/241203 ([0010]-[0074], [0090]-[00109]); WO 2019/241234 ([0012]-[0079], [00115]-[00153]), Tillet et al., “Chemical Reactions of Polymer Crosslinking and Post-Crosslinking at room and medium temperature”, Progress in Polymer Science 36 (2011) 191-217 (pages 193-213), which references are each incorporated herein by reference.

The low temperature cure coating composition may comprise a polyhydrazide-containing curable aqueous composition comprising: (i) a continuous phase comprising water, and (ii) a dispersed phase comprising: (A) polymeric particles prepared from the polymerization of a mixture of ethylenically unsaturated monomer compounds, including ethylenically unsaturated monomers comprising: (1) a multi-ethylenically unsaturated monomer and (2) an aldo or keto group-containing ethylenically unsaturated monomer; and (B) a hydrophobic polyester prepared from polymerizing the following mixture of monomers: (1) a polyacid component comprising a dimer fatty acid and a tricarboxylic acid; and (11) a polyol component comprising a diol and a diol with carboxylic acid groups, as described in US 2016/0068706 ([0041]-[0086]).

The low temperature cure coating composition may comprise an aqueous dispersion comprising an aqueous medium and self-crosslinkable core-shell particles dispersed in the aqueous medium, wherein the core-shell particles comprise (1) a polymeric core at least partially encapsulated by (2) a polymeric shell comprising urethane linkages, keto and/or aldo functional groups, and hydrazide functional groups, and wherein the polymeric core is covalently bonded to at least a portion of the polymeric shell, as described in US 2019/0002709 ([0008]-[0065], [0128]-[0141]).

The low temperature cure coating composition may comprise a polyhydrazide and core-shell particles dispersed in an aqueous medium, the core-shell particles comprising (1) a polymeric core at least partially encapsulated by (2) a polymeric shell comprising urea linkages, and keto and/or aldo functional groups, as described in WO 2017/160398 ([0007]-[0063], [0097]-[00131]).

The low temperature cure coating composition may comprise a free polyisocyanate and hydroxyl functional polymeric core-shell particles, wherein a polymeric core and a polymeric shell of the hydroxyl functional core-shell particles each independently comprise an addition polymer derived from ethylenically unsaturated monomers. A second low temperature cure coating composition maybe applied thereover to form a multi-layer coated substrate, the second low temperature cure coating composition comprising carboxylic acid functional polymeric core-shell particles, wherein a polymeric core of the carboxylic acid functional core-shell particles comprises an addition polymer derived from ethylenically unsaturated monomers and a polymeric shell of the carboxylic acid functional core-shell particles comprises urethane linkages and carboxylic acid functional groups, as described in WO 2019/241203 ([0010]-[0074], [0090]-[00109]).

The low temperature cure coating composition may comprise: (a) a melamine resin comprising imino and methylol functional groups that together comprise 30 mole % or greater of the total functionality of the melamine resin; and (b) at least one polymer reactive with (a) that is obtained from components comprising polytetrahydrofuran and a carboxylic acid or anhydride thereof, wherein the polytetrahydrofuran comprises greater than 20 weight % of the components that form the polymer (b) and the carboxylic acid or anhydride thereof comprises greater than 5 weight % of the components that form the polymer (b), and wherein the polymer (b) has an acid value of at least 15 based on the total resin solids of the polymer (b), as described in WO 2019/241234 ([0012]-[0079], [00115]-[00153]).

The low temperature cure coating composition may comprise core-shell particles comprising (1) a polymeric acrylic core at least partially encapsulated by (2) a polymeric shell comprising urethane and/or urea linkages, wherein the polymeric shell comprises carboxylic acid functionality. The polymeric core and/or the polymeric shell may include keto functionality. The polymeric shell may include hydrazide functionality. The low temperature cure coating composition may further comprise a crosslinker reactive with the acid functional groups, such as carbodiimide. The low temperature cure coating composition may further comprise a crosslinker reactive with the keto functional groups, such as a hydrazide crosslinker. The hydrazide crosslinker may be included in addition to or in lieu of hydrazide functionality being incorporated on the polymeric shell

The low temperature cure coating composition may comprise a resin comprising self-crosslinkable: acrylamide and/or aldehyde and/or azetidine functional groups, where the self-crosslinkable groups may undergo a crosslinking reaction at a temperature of up to 140° C. Such low temperature self-crosslinking reactions are described in Tillet et al. The low temperature cure coating composition may comprise a resin and a crosslinker, wherein the resin and the crosslinker undergo a crosslinking reaction at a temperature of up to 140° C. between: a carboxylic acid functional group and at least one of a carbodiimide, an aziridine, an epoxide, and/or an oxazoline functional group; an acetoacetyl functional group and at least one of an isocyanate, an activated alkene, an aldehyde, and/or an amine functional group; an amine functional group and at least one of an acetylacetonate, an aldehyde, a ketone and/or an epoxide functional group; an acetal function group and an amine functional group; a hydroxyl functional group and at least one of a protected urethane, an azlactone, and/or a methylol amide functional group; an azido functional group and a carbon-carbon triple bond; and/or two functional groups capable of undergoing a Diels-Alder reaction. Such low temperature crosslinking reactions are described in Tillet et al. The coating composition may include a suitable catalyst to initiate any of the above-described crosslinking reactions as described in Tillet et al. The low temperature cure coating composition may comprise a resin and a crosslinker, wherein the resin and the crosslinker undergo a crosslinking reaction at a temperature of up to 140° C. between a thiol functional group and a carbon-carbon double bond.

The present invention also relates to a system for applying a coating composition over at least a portion of a substrate. The system includes: the previously described coating composition comprising a film-forming resin dispersed in an aqueous medium, a crosslinker reactive with the film-forming resin, a rheology modifier, a colorant, a swelling solvent that swells the film-forming resin, and solids content of the coating composition is less than 25 weight %, based on the total weight of the coating composition; and a device configured to apply the coating composition over at least a portion of the substrate without overspray.

It should be appreciated that the coating composition can comprise any of the components and amounts of components previously described. Further, the device can include any of the devices configured to apply coating compositions precisely without overspray and which do not require masking the substrate. For example, the device can be selected from a device that apply s the composition as a continuous jet, as continuous droplets, and/or as a drop on-demand as previously described.

The system can also include additional components such as additional coating compositions for various applications. For instance, the system can include additional coating compositions that the device can apply and apply over the substrate along with the coating composition of the present invention. The additional coating compositions can be applied over the coating composition of the present invention and/or prior to application of the coating composition of the present invention to form a multi-layer coating system such as the previously described multi-layer coatings. The additional coating compositions can also be applied by the device over different portions of the substrate to provide different colors or other visual effects on the different portions of the substrate.

The system of the present invention can apply the coating composition without overspray in a single application to provide desirable coating properties over a substrate. The coatings provided by the system of the present invention can also be formed at lower dehydration/cure temperatures than those typically required in other coatings such as coatings commonly applied to automotive substrates.

The present invention is also directed to a method of applying a coating composition over at least a portion of a substrate. The method comprises applying the previously described coating composition of the present invention over at least a portion of a substrate with a device configured to apply the coating composition without overspray. It should be appreciated that the coating composition can comprise any of the components and amounts of components previously described. Further, the device can include any of the devices configured to apply coating compositions precisely without overspray and which do not require masking the substrate.

The method can further comprise dehydrating and/or curing the coating composition to form a coating layer of the substrate. For instance, the method can further comprise dehydrating and/or curing the coating composition at ambient temperatures (20° C. to 25° C.) to 140° C., or from ambient temperatures to 120° C., or from ambient temperatures to 100° C., or from ambient temperatures to 90° C., or from 40° C. to 80° C., or from 50° C. to 80° C.

The method may comprise applying two or more coating compositions to forma multi-layer coating. As such, the method can further comprise applying the coating composition of the present invention over at least a portion of a second coating composition previously applied to the substrate, and/or applying a second or third coating composition over at least a portion of the coating composition of the present invention. The coating compositions can also be applied over the substrate in a single pass.

As indicated, the method of applying a coating composition to a substrate can be used to form a multi-layer coating system over a substrate. It should be appreciated that the multi-layer coatings can include at least two basecoat such as with basecoats applied to automotive substrates. Such methods can comprise: forming a first basecoat layer over at least a portion of a substrate by applying a first basecoat composition onto at least a portion of the substrate using a device that prevents overspray; and forming a second basecoat layer over at least a portion of the first basecoat layer by applying a second basecoat composition directly onto at least a portion of: (1) the first basecoat layer using a device that prevents overspray after the first basecoat composition is dehydrated and/or cured; or (2) the first basecoat composition using a device that prevents overspray before the first basecoat composition is dehydrated and/or cured.

The first and second basecoat compositions can be dehydrated and/or cured separately or simultaneously at ambient temperatures (20° C. to 25° C.) to 140° C., or from ambient temperatures to 120° C., or from ambient temperatures to 100° C., or from ambient temperatures to 90° C., or from 40° C. to 80° C., or from 50° C. to 80° C. Optionally, the method may include forming a topcoat layer over at least a portion of the second basecoat layer by applying a topcoat composition onto at least a portion of the second basecoat layer using a device that prevents overspray.

The substrate can also comprise a primer coating layer and the first basecoat layer may be applied over at least a portion of the primer coating layer by applying a first basecoat composition directly onto at least a portion of the primer coating layer using a device that prevents overspray. The primer coating layer can be formed by applying a primer coating composition, such as by electrodepositing an electrodepositable coating composition, onto at least a portion of the substrate prior to applying the first basecoat composition.

It should be appreciated that the coatings can be applied to automotive parts in an automotive assembly plant. During application of the multi-layer coating system in an automotive assembly plant, a metal substrate may be passed through various stations where at least some of the devices are configured to apply compositions without overspray as previously described.

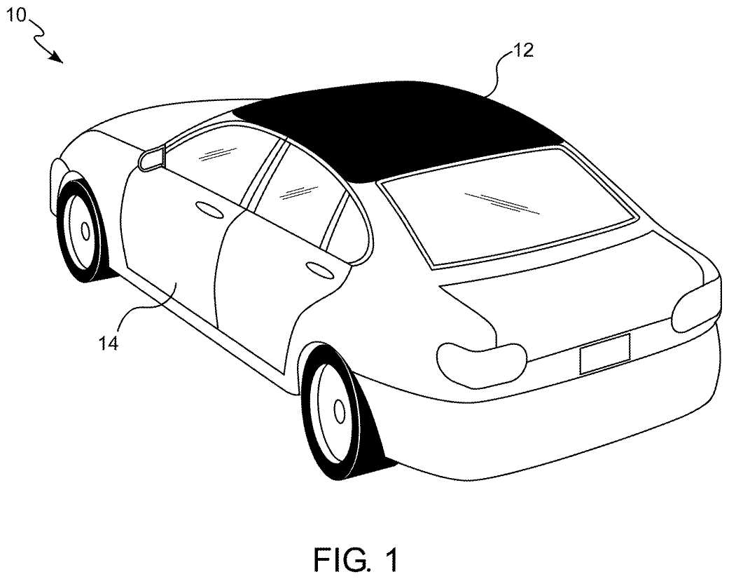

Referring to FIG. 1, a vehicle 10 (e.g., an automobile) is shown prepared using the coating, system, and method described herein. The vehicle 10 may have a vehicle body that has a first region 12 and a second region 14. The first region 12 may be coated with a coating composition having a first color (e.g., black in FIG. 1), while the second region 14 may be coated with a coating composition have a second color (e.g., white in FIG. 1) so as to form a two-tone vehicle. The coating composition applied over the first region 12 and/or the coating composition applied over the second region 14 may be the coating composition for precision application described herein. The coating composition applied over the first region 12 and/or the coating composition applied over the second region 14 may be applied thereover using the system described herein. The coating composition applied over the first region 12 and/or the coating composition applied over the second region 14 may be applied thereover according to the method described herein. The first region 12 and/or the second region 14 may include the multi-layer system as described herein. The coating composition applied over the first region 12 and/or the coating composition applied over the second region 14 may be applied thereover in a single pass and/or without masking the vehicle 10 to produce the two-tone vehicle. While FIG. 1 shows the first region 12 including the roof of the vehicle and the second region 14 including the remainder of the vehicle body, it should be appreciated that the first and second regions 12, 14 may include different regions of the vehicle body. Additionally, more than two regions may be included to form a multi-tone vehicle.

In view of the foregoing description and examples, the present invention thus relates inter alia to the subject matter of the following clauses though being not limited thereto.

Clause 1: A coating composition for precision application, as in particular for use in a system according to any of clauses 18-37 or for use in a method according to any of clauses 38-47, comprising: a film-forming resin dispersed in an aqueous medium; a crosslinker reactive with the film-forming resin; a rheology modifier; a colorant; and a swelling solvent that swells the film-forming resin, wherein the solids content of the coating composition is less than 25 weight %, based on the total weight of the coating composition.

Clause 2: The coating composition of clause 1, wherein the film-forming resin comprises urethane linkages and carboxylic acid and hydroxyl functional groups.

Clause 3: The coating composition of clause 2, wherein the film-forming resin comprises a core-shell particle comprising a polymeric core at least partially encapsulated by a polymeric shell comprising the urethane linkages and carboxylic acid and hydroxyl functional groups, and wherein the polymeric shell is covalently bonded to at least a portion of the polymeric core.

Clause 4: The coating composition of clause 3, wherein at least a portion of the polymeric core of the core-shell particles comprises an addition polymer formed from (meth)acrylic monomers, vinyl monomers, or combinations thereof.

Clause 5: The coating composition of any of clauses 1-4, wherein the crosslinker comprises an aminoplast.

Clause 6: The coating composition of any of clauses 1-5, wherein the rheology modifier comprises an alkali swellable polymer and a wax.

Clause 7: The coating composition of clause 6, wherein the wax of the rheology modifier comprises an ethylene vinyl acetate copolymer wax.

Clause 8: The coating composition of any of clauses 1-7, wherein the colorant comprises a black colorant.

Clause 9: The coating composition of any of clauses 1-8, wherein the swelling solvent comprises at least one alcohol.

Clause 10: The coating composition of any of clauses 1-9, wherein the solids content of the coating composition is less than 15 weight %, based on the total weight of the coating composition.

Clause 11: The coating composition of any of clauses 1-10, wherein the solids content of the coating composition is from 8 weight % to 12 weight %, based on the total weight of the coating composition.

Clause 12: The coating composition of any of clauses 1-11, wherein the coating composition comprises 20 weight % or less of the rheology modifier, based on the total weight of the coating composition.

Clause 13: The coating composition of any of clauses 1-12, wherein the coating composition has a high-shear viscosity of from 60 to 110 mPa s at shear rate of 1000 s⁻¹, as determine according to ASTM 2196-15 Method B Spindle No LV-1.

Clause 14: The coating composition of any of clauses 1-13, wherein the coating composition has a low-shear viscosity of from 3 to 32 Pa·s, such as 3 to 30 or 7 to 15 Pa·s at shear rate of 0.1 s⁻¹, as determine according to ASTM 2196-15 Method B Spindle No LV-1.

Clause 15: The coating composition of any of clauses 1-14, wherein the coating composition further comprises a hydroxyl functional polyester.

Clause 16: The coating composition of any of clauses 1-15, wherein the coating composition further comprises a (meth)acrylic polymer dispersed in an aqueous medium.

Clause 17: The coating composition of any of clauses 1-16, wherein a difference in a surface tension of a substrate coated with a clear topcoat and a surface tension of the coating composition (surface tension (clear coated substrate)−surface tension (coating composition)) is greater than 0, such as greater than 2.

Clause 18: A system for precision application of a coating composition over at least a portion of a substrate, as in particular performing the method according to any of clauses 38-47, the system comprising: a coating composition, as in particular a coating composition according to any of clauses 1-17, comprising: a film-forming resin dispersed in an aqueous medium; a crosslinker reactive with the film-forming resin; a rheology modifier; a colorant; and a swelling solvent that swells the film-forming resin, wherein the solids content of the coating composition is less than 25 weight %, based on the total weight of the coating composition; and a device configured to apply the coating composition over at least a portion of the substrate without overspray.

Clause 19: The system of clause 18, wherein the substrate is not masked with a removable material.

Clause 20: The system of clause 18 or 19, wherein the device is configured to produce a desired pattern and/or design over the substrate.

Clause 21: The system of any of clauses 18-20, wherein the device is configured to apply the coating composition as a continuous jet, as continuous droplets, and/or as a drop on-demand.

Clause 22: The system of any of clauses 18-21, wherein the film-forming resin comprises urethane linkages and carboxylic acid and hydroxyl functional groups.

Clause 23: The system of clause 22, wherein the film-forming resin comprises a core-shell particle comprising a polymeric core at least partially encapsulated by a polymeric shell comprising the urethane linkages and carboxylic acid and hydroxyl functional groups, and wherein the polymeric shell is covalently bonded to at least a portion of the polymeric core.

Clause 24: The system of clause 23, wherein at least a portion of the polymeric core of the core-shell particles comprises an addition polymer formed from (meth)acrylic monomers, vinyl monomers, or combinations thereof.

Clause 25: The system of any of clauses 18-24, wherein the crosslinker comprises an aminoplast.

Clause 26: The system of any of any of clauses 18-25, wherein the rheology modifier comprises an alkali swellable polymer and a wax.

Clause 27: The system of clause 26, wherein the wax of the rheology modifier comprises an ethylene vinyl acetate copolymer wax.

Clause 28: The system of any of clauses 18-27, wherein the colorant comprises a black colorant.

Clause 29: The system of any of clauses 18-28, wherein the swelling solvent comprises at least one alcohol.

Clause 30: The system of any of clauses 18-29, wherein the solids content of the coating composition is less than 15 weight %, based on the total weight of the coating composition.

Clause 31: The system of any of clauses 18-30, wherein the solids content of the coating composition is from 8 weight % to 12 weight %, based on the total weight of the coating composition.

Clause 32: The system of any of clauses 18-31, wherein the coating composition comprises 20 weight % or less of the rheology modifier, based on the total weight of the coating composition.

Clause 33: The system of any of clauses 18-32, wherein the coating composition has a high-shear viscosity of from 60 to 110 mPa·s at shear rate of 1000 s⁻¹, as determine according to ASTM 2196-15 Method B Spindle No LV-1.

Clause 34: The system of any of clauses 18-33, where the coating composition has a low-shear viscosity of from 3 to 32 Pa·s, such as 3 to 30 or 7 to 15 Pa·s at shear rate of 0.1 s⁻¹, as determine according to ASTM 2196-15 Method B Spindle No LV-1.

Clause 35: The system of any of clauses 18-34, wherein the coating composition further comprises a hydroxyl functional polyester.

Clause 36: The system of any of clauses 18-35, wherein the coating composition further comprises a (meth)acrylic polymer dispersed in an aqueous medium.

Clause 37: The system of any of clauses 18-36, wherein, when the device is configured to apply the coating composition over the substrate, such that when the coating composition is cured to form a coating, the coating has a dry film thickness of 20 microns or less.

Clause 38: A method for precision application of a coating composition over at least a portion of a substrate, as in particular using the system according to any of clauses 18-37, comprising: applying the coating composition according to any of clauses 1-17 over at least a portion of the substrate with a device configured to apply the coating composition, particularly without overspray.

Clause 39: The method of clause 38, wherein the coating composition is applied over at least a portion of a second coating composition previously applied to the substrate.

Clause 40: The method of clause 38 or 39, further comprising applying a second coating composition over at least a portion of the coating composition.

Clause 41: The method of any of clauses 38-40, wherein the coating composition is applied over the substrate in a single pass.

Clause 42: The method of any of clauses 38-41, wherein the coating composition forms at least one of two basecoat layers, and the method further comprises curing each basecoat composition that forms the basecoat layers simultaneously at a temperature of 120° C. or less.

Clause 43: The method of any of clauses 38-42, wherein when the coating composition is applied over the substrate and cured to form a coating, the coating has a dry film thickness of 20 microns or less.

Clause 44: The method of any of clauses 38-43, wherein the substrate is not masked with a removable material during application of the coating composition over the substrate.

Clause 45: The method of any of clauses 38-44, wherein the substrate is positioned substantially vertical relative to the ground, wherein the coating composition has a high-shear viscosity of from 60 to 110 mPa·s at shear rate of 1000 s⁻¹ and/or a low-shear viscosity of from 15 to 32 Pa·s at shear rate of 0.1 s⁻¹, as determine according to ASTM 2196-15 Method B Spindle No LV-1.

Clause 46: The method of any of clauses 38-45, wherein the substrate is positioned substantially horizontal relative to the ground, wherein the coating composition has a high-shear viscosity of from 60 to 100 mPa·s at shear rate of 1000 s⁻¹ and/or a low-shear viscosity of from 3 to 20 Pa·s at shear rate of 0.1 s⁻¹, as determine according to ASTM 2196-15 Method B Spindle No LV-1.

Clause 47: The method of any of clauses 38-46, further comprising: applying a low temperature cure coating composition that when cured to form a layer having a thickness of 35 μm by baking at 80° C. for 30 minutes, the layer achieves 100 MEK double rubs as measured according to ASTM D5402-19 over at least a portion of the substrate to form a low temperature cure layer, wherein the coating composition is applied over at least a portion of the low temperature cure layer.

Clause 48: A substrate at least partially coated, as in particular performing the method according to any of clauses 38-47, with the coating composition of any of clauses 1-17.

Clause 49: The substrate of clause 48, wherein the substrate comprises a vehicle substrate.

Clause 50: A substrate coated with a multi-layer coating system, wherein the multi-layer coating system comprises: a first basecoat layer positioned over at least a portion of the substrate; and a second basecoat layer positioned over at least a portion of the first basecoat layer, wherein the first basecoat layer is formed from a first basecoat composition that when cured to form a layer having a thickness of 35 μm by baking at 80° C. for 30 minutes, the layer achieves 100 MEK double rubs as measured according to ASTM D5402-19, wherein the second basecoat layer is formed from a second basecoat composition comprising: a film-forming resin dispersed in an aqueous medium; a crosslinker reactive with the film-forming resin; and a colorant; wherein the solids content of the second basecoat composition is less than 25 weight %, based on the total weight of the second basecoat composition.

Clause 51: The substrate of clause 50, wherein the substrate comprises a vehicle substrate.

Clause 52: The substrate of clause 50 or 51, wherein the first basecoat composition comprises a polyhydrazide-containing curable aqueous composition comprising: (i) a continuous phase comprising water, and (ii) a dispersed phase comprising: (A) polymeric particles prepared from the polymerization of a mixture of ethylenically unsaturated monomer compounds, including ethylenically unsaturated monomers comprising: (1) a multi-ethylenically unsaturated monomer, and (2) an aldo or keto group-containing ethylenically unsaturated monomer; and (B) a hydrophobic polyester prepared from polymerizing the following mixture of monomers: (I) a polyacid component comprising a dimer fatty acid and a tricarboxylic acid; and (II) a polyol component comprising a diol and a diol with carboxylic acid groups.

Clause 53: The substrate of any of clauses 50-52, wherein the first basecoat composition comprises an aqueous dispersion comprising an aqueous medium and self-crosslinkable core-shell particles dispersed in the aqueous medium, wherein the core-shell particles comprise (1) a polymeric core at least partially encapsulated by (2) a polymeric shell comprising urethane linkages, keto and/or aldo functional groups, and hydrazide functional groups, and wherein the polymeric core is covalently bonded to at least a portion of the polymeric shell.

Clause 54: The substrate of any of clauses 50-53, wherein the first basecoat composition comprises: a polyhydrazide and core-shell particles dispersed in an aqueous medium, the core-shell particles comprising (1) a polymeric core at least partially encapsulated by (2) a polymeric shell comprising urea linkages, and keto and/or aldo functional groups.

Clause 55: The substrate of any of clauses 50-54, wherein the first basecoat composition comprises: a free polyisocyanate and hydroxyl functional polymeric core-shell particles, wherein a polymeric core and a polymeric shell of the hydroxyl functional core-shell particles each independently comprise an addition polymer derived from ethylenically unsaturated monomers.

Clause 56: The substrate of clause 55, comprising a third basecoat layer positioned over at least a portion of the first basecoat layer and under at least a portion of the second basecoat layer, wherein the third basecoat layer is formed from a third basecoat composition, wherein the third basecoat composition comprises carboxylic acid functional polymeric core-shell particles, wherein a polymeric core of the carboxylic acid functional core-shell particles comprises an addition polymer derived from ethylenically unsaturated monomers and a polymeric shell of the carboxylic acid functional core-shell particles comprises urethane linkages and carboxylic acid functional groups.

Clause 57: The substrate of any of clauses 50-56, wherein the first basecoat composition comprises: (a) a melamine resin comprising imino and methylol functional groups that together comprise 30 mole % or greater of the total functionality of the melamine resin; and (b) at least one polymer reactive with (a) that is obtained from components comprising polytetrahydrofuran and a carboxylic acid or anhydride thereof, wherein the polytetrahydrofuran comprises greater than 20 weight % of the components that form the polymer (b) and the carboxylic acid or anhydride thereof comprises greater than 5 weight % of the components that form the polymer (b), and wherein the polymer (b) has an acid value of at least 15 based on the total resin solids of the polymer (b).

Clause 58: The substrate of any of clauses 50-57, wherein the first basecoat composition comprises: core-shell particles comprising (1) a polymeric acrylic core comprising at least partially encapsulated by (2) a polymeric shell comprising urethane and/or urea linkages, wherein the polymeric shell comprises carboxylic acid functionality, wherein the polymeric core and/or the polymeric shell comprises keto functionality.

Clause 59: The substrate of clause 58, wherein the first basecoat composition further comprises a crosslinker.

Clause 60: The substrate of any of clauses 50-59, wherein the first basecoat composition comprises: a resin comprising self-crosslinkable acrylamide and/or aldehyde and/or azetidine functional groups; and/or a resin and a crosslinker, wherein the resin and the crosslinker undergo a crosslinking reaction at a temperature of up to 140° C. between: a carboxylic acid functional group and a carbodiimide, an aziridine, an epoxide, and/or an oxazoline functional group; an acetoacetyl functional group and an isocyanate, an activated alkene, an aldehyde, and/or an amine functional group; an amine functional group and an acetylacetonate, an aldehyde, a ketone and/or an epoxide functional group; an acetal function group and an amine functional group; a hydroxyl functional group and a protected urethane, an azlactone, and/or a methylol amide functional group; an azido functional group and a carbon-carbon triple bond; a thiol functional group and a carbon-carbon double bond; and/or two functional groups capable of undergoing a Diels-Alder reaction.

Clause 61: The substrate of any of clauses 50-60, wherein the second basecoat composition further comprises: a rheology modifier; and a swelling solvent that swells the film-forming resin.

Clause 62: A substrate coated with a multi-layer coating system, as in particular performing the method according to any of clauses 3847, wherein the multi-layer coating system comprises: a first basecoat layer positioned over at least a portion of the substrate; and a second basecoat layer positioned over at least a portion of the first basecoat layer, wherein the second basecoat layer is formed from a second basecoat composition, as in particular a coating composition according to any of clauses 1-17, comprising: a film-forming resin dispersed in an aqueous medium; a crosslinker reactive with the film-forming resin; and a colorant; wherein a solids content of the second basecoat composition is less than 25 weight %, based on the total weight of the second basecoat composition.

Clause 63: The substrate of clause 62, wherein the first basecoat layer is formed from a first basecoat composition that when cured to form a layer having a thickness of 35 μm by baking at 80° C. for 30 minutes, the layer achieves 100 MEK double rubs as measured according to ASTM D5402-19.

Clause 64: The substrate of any of clauses 62 or 63, wherein the substrate comprises a vehicle substrate.

Clause 65: The substrate of any of clauses 62-64, wherein the first basecoat composition comprises a polyhydrazide-containing curable aqueous composition comprising: (i) a continuous phase comprising water, and (ii) a dispersed phase comprising: (A) polymeric particles prepared from the polymerization of a mixture of ethylenically unsaturated monomer compounds, including ethylenically unsaturated monomers comprising: (1) a multi-ethylenically unsaturated monomer, and (2) an aldo or keto group-containing ethylenically unsaturated monomer; and (B) a hydrophobic polyester prepared from polymerizing the following mixture of monomers: (I) a polyacid component comprising a dimer fatty acid and a tricarboxylic acid; and (II) a polyol component comprising a diol and a diol with carboxylic acid groups.

Clause 66: The substrate ofany of clauses 62-65, wherein the first basecoat composition comprises an aqueous dispersion comprising an aqueous medium and self-crosslinkable core-shell particles dispersed in the aqueous medium, wherein the core-shell particles comprise (1) a polymeric core at least partially encapsulated by (2) a polymeric shell comprising urethane linkages, keto and/or aldo functional groups, and hydrazide functional groups, and wherein the polymeric core is covalently bonded to at least a portion of the polymeric shell.

Clause 67: The substrate of any of clauses 62-66, wherein the first basecoat composition comprises: a polyhydrazide and core-shell particles dispersed in an aqueous medium, the core-shell particles comprising (1) a polymeric core at least partially encapsulated by (2) a polymeric shell comprising urea linkages, and keto and/or aldo functional groups.

Clause 68: The substrate of any of clauses 62-67, wherein the first basecoat composition comprises: a free polyisocyanate and hydroxyl functional polymeric core-shell particles, wherein a polymeric core and a polymeric shell of the hydroxyl functional core-shell particles each independently comprise an addition polymer derived from ethylenically unsaturated monomers.

Clause 69: The substrate of any of clauses 62-68, comprising a third basecoat layer positioned over at least a portion of the first basecoat layer and under at least a portion of the second basecoat layer, wherein the third basecoat layer is formed from a third basecoat composition, wherein the third basecoat composition comprises carboxylic acid functional polymeric core-shell particles, wherein a polymeric core of the carboxylic acid functional core-shell particles comprises an addition polymer derived from ethylenically unsaturated monomers and a polymeric shell of the carboxylic acid functional core-shell particles comprises urethane linkages and carboxylic acid functional groups.

Clause 70: The substrate of any of clauses 62-69, wherein the first basecoat composition comprises: (a) a melamine resin comprising imino and methylol functional groups that together comprise 30 mole % or greater of the total functionality of the melamine resin; and (b) at least one polymer reactive with (a) that is obtained from components comprising polytetrahydrofuran and a carboxylic acid or anhydride thereof, wherein the polytetrahydrofuran comprises greater than 20 weight % of the components that form the polymer (b) and the carboxylic acid or anhydride thereof comprises greater than 5 weight % of the components that form the polymer (b), and wherein the polymer (b) has an acid value of at least 15 based on the total resin solids of the polymer (b).

Clause 71: The substrate of any of clauses 62-70, wherein the first basecoat composition comprises: core-shell particles comprising (1) a polymeric acrylic core comprising keto functionality at least partially encapsulated by (2) a polymeric shell comprising urethane and/or urea linkages, wherein the polymeric shell comprises carboxylic acid functionality.

Clause 72: The substrate of any of clauses 62-71, wherein the first basecoat composition further comprises a crosslinker.

Clause 73: The substrate of any of clauses 62-72, wherein the first basecoat composition comprises:

Clause 74: The substrate of any of clauses 62-73, wherein the second basecoat composition further comprises: a rheology modifier; and a swelling solvent that swells the film-forming resin.

Clause 75: A method for precision application of a coating composition over at least a portion of a substrate, as in particular using the system according to any of clauses 18-37, comprising: forming a first basecoat from a first basecoat composition, as in particular using the coating composition according to any of clauses 1-17, in a first area of a substrate (or vehicle) and forming a second basecoat from a second basecoat composition, as in particular using the coating composition according to any of clauses 1-17, in a second area of a substrate, optionally forming a third coating such as a topcoat over at least a portion of the first and second basecoat, wherein the first area and the second area are adjacent to each other and not masked with a removable material during the application of the first and second basecoat composition.

Clause 76: The method of clause 75, further comprising forming a low temperature cure basecoat from a low temperature cure composition, as in particular using the first basecoat composition according to any of claims 50-61, over the first area and/or the second area of the substrate, wherein the low temperature cure basecoat underlies at least a portion of the first basecoat and/or the second basecoat.

Clause 77: The method of clause 76, wherein the low temperature cure basecoat is in direct contact with at least a portion of the first basecoat and/or the second basecoat.

### EXAMPLES

The following examples are presented to demonstrate the general principles of the invention. The invention should not be considered as limited to the specific examples presented.

### Examples 1-12

### Formulation of Black Coating Compositions for Precision Application

To prepare the precision application coating composition of Example 11, to a stainless steel container was added 47 g deionized (DI) water, 7.71 g of polyester A, 2.53 g of the acrylic latex A, 3.08 g acrylic latex B, 0.64 g of polyester B, and an additional 1.0 g of DI water. The mixture was agitated with a high-lift blade attached to an air motor for the duration of formulation. To this mixture, 0.87 g of BYK 349, 0.34 g BYKETOL WS, 0.35 g 50% SURFYNOL 104E in ethylene glycol, and 0.17 g of BYK 011 was added, followed by 1.96 g of DOWANOL PnB, 1.95 g 2-butoxyethanol, and 0.34 g of 2-ethylhexanol. To this mixture was added 2.4 g of CYMEL 327 melamine resin. To this mixture, 0.29 g of SBP 140/165 and 0.29 g of SHELLSOL D70 was added. Separately, a premixture of AQUATIX 8412 and DI water was mixed in a 1:1 ratio, and 10.60 g was added to the mixture. To the mixture was added 0.26 g DI water, and the amount of 50% dimethyl ethanolamine in water which yielded a pH of 8.6, about 0.32 g. To the mixture, the following were added successively: 11.27 g black tint paste, 0.13 g white tint, and 0.42 g ALCUPOL D-1011. Then, 4.9 g of the AQUATIX premixture was added. Agitation was ceased, and the mixture was allowed to rest for a minimum of 12 hours. Then, DI water and 50% dimethyl ethanolamine in water were added to adjust the pH to 8.6 and the viscosity as measured by a CAP2000 viscometer fitted with a #4 spindle at 300 RPM to 100 cP, which was approximately 0.71 g of DI water and 0.51 g of 50% dimethyl ethanolamine.

All other formulations were prepared using similar procedures. The formulations of Examples 1-12 are shown in Table 1.

TABLE 1
Coating Composition Formulations

| | Example | | | | | | | | | | | |
|---|---|---|---|---|---|---|---|---|---|---|---|---|
| Component | 1 | 2 | 3 | 4 | 5 | 6 | 7 | 8 | 9 | 10 | 11 | 12 |
| Polyester A¹ | 153.45 | 196.82 | 153.09 | 153.29 | 153.09 | 153.09 | 5.72 | 7.06 | 7.07 | 17.97 | 7.71 | 5.38 |
| Latex A² | 50.29 | 64.50 | 50.17 | 50.24 | 50.17 | 50.17 | 1.88 | 2.31 | 2.32 | 11.43 | 2.53 | 4.28 |
| Latex B³ | 61.29 | 78.62 | 61.15 | 61.23 | 61.15 | 61.15 | 2.29 | 2.82 | 2.82 | 0.00 | 3.08 | 0.00 |
| Latex C⁴ | 0.00 | 0.00 | 0.00 | 0.00 | 0.00 | 0.00 | 0.00 | 0.00 | 6.00 | 8.42 | 0.00 | 1.91 |
| Deionized water | 1311.4 | 1671.7 | 1270.0 | 1323.4 | 1313.8 | 1324.9 | 60.9 | 51.5 | 54.3 | 15.4 | 56.7 | 61.3 |
| BYK-348⁵ | 10.63 | 13.64 | 10.61 | 10.62 | 10.61 | 10.61 | 0.40 | 0.49 | 0.56 | 0.1 | 0.00 | 0.03 |
| BYK-349⁶ | 0.00 | 0.00 | 0.00 | 0.00 | 0.00 | 0.00 | 0.00 | 0.00 | 0.00 | 0.00 | 0.87 | 0.00 |
| BYK-011⁷ | 4.32 | 5.54 | 4.31 | 4.32 | 4.31 | 4.31 | 0.16 | 0.2 | 9.14 | 0.26 | 0.17 | 0.2 |
| 50% SURFYNOL | 6.91 | 8.86 | 6.89 | 6.90 | 6.89 | 6.89 | 0.26 | 0.32 | 0.32 | 0.00 | 0.35 | 0.00 |
| 104E²⁴ in | | | | | | | | | | | | |
| ethylene glycol | | | | | | | | | | | | |
| 2-ethylhexanol | 6.69 | 8.58 | 6.67 | 6.68 | 6.67 | 6.67 | 0.25 | 0.31 | 0.31 | 4.74 | 0.34 | 0.67 |
| CYMEL 327⁸ | 54.13 | 69.43 | 54.00 | 54.07 | 54.00 | 54.00 | 2.02 | 2.49 | 2.19 | 0.00 | 2.4 | 0.00 |
| CYMEL 303⁹ | 0.00 | 0.00 | 0.00 | 0.00 | 0.00 | 0.00 | 0.00 | 0.00 | 0.00 | 4.32 | 0.00 | 0.98 |
| Cymel 1158¹⁰ | 0.00 | 0.00 | 0.00 | 0.00 | 0.00 | 0.00 | 0.00 | 0.00 | 0.00 | 1.81 | 0.00 | 0.41 |
| hexyl cellosolve | 0.00 | 0.00 | 0.00 | 0.00 | 0.00 | 0.00 | 0.00 | 0.00 | 0.00 | 1.4 | 0.00 | 0.42 |
| 2-butoxyethanol | 38.85 | 49.83 | 38.76 | 38.81 | 38.76 | 38.76 | 1.45 | 1.79 | 1.79 | 0.00 | 1.95 | 0.00 |
| SBP 140/165¹¹ | 5.83 | 7.47 | 5.81 | 5.82 | 5.81 | 5.81 | 0.22 | 0.27 | 0.27 | 0.43 | 0.29 | 0.13 |
| SHELLSOL D70¹² | 5.83 | 7.47 | 5.81 | 5.82 | 5.81 | 5.81 | 0.22 | 0.27 | 0.27 | 0.43 | 0.29 | 0.13 |
| 50% DMEA¹³ | 17.04 | 18.96 | 23.14 | 21.54 | 21.38 | 22.66 | 0.88 | 0.92 | 0.69 | 0.030 | 0.83 | 1.02 |
| Black tint¹⁴ | 282.8 | 362.74 | 282.14 | 281.52 | 282.14 | 282.14 | 10.55 | 13.01 | 8.3 | 28.31 | 11.27 | 9.42 |
| White tint¹⁵ | 3.05 | 3.91 | 3.04 | 3.05 | 3.04 | 3.04 | 0.11 | 0.14 | 0.09 | 0.18 | 0.13 | 0.06 |
| Polyester B¹⁶ | 12.73 | 16.33 | 12.70 | 12.72 | 12.70 | 12.70 | 0.48 | 0.59 | 0.59 | 0.00 | 0.64 | 0.00 |
| ALCUPOL D-1011¹⁷ | 8.42 | 10.80 | 8.40 | 8.41 | 8.40 | 8.40 | 0.31 | 0.39 | 0.39 | 2.6 | 0.42 | 1.15 |
| Urethane Diol¹⁸ | 0.00 | 0.00 | 0.00 | 0.00 | 0.00 | 0.00 | 0.00 | 0.00 | 0.00 | 0.00 | 0.00 | 0.61 |
| DOWANOL PnB¹⁹ | 39.06 | 50.11 | 38.97 | 39.02 | 38.97 | 38.97 | 1.46 | 1.80 | 1.80 | 0.00 | 1.96 | 0.90 |
| BYKETOL WS²⁰ | 6.69 | 8.58 | 6.67 | 6.68 | 6.67 | 6.67 | 0.25 | 0.31 | 0.31 | 1.56 | 0.34 | 0.59 |
| AQUATIX 8421²¹ | 135.60 | 192.00 | 175.79 | 202.00 | 218.19 | 234.23 | 0.00 | 0.00 | 15.52 | 0.58 | 7.75 | 7.95 |
| 7% ASE 60²² | 0.00 | 0.00 | 0.00 | 0.00 | 0.00 | 0.00 | 0.00 | 13.05 | 0.00 | 0.00 | 0.00 | 0.00 |
| RHEOVIS AS 1130²³ | 0.00 | 0.00 | 0.00 | 0.00 | 0.00 | 0.00 | 10.21 | 0.00 | 0.00 | 0.00 | 0.00 | 0.00 |

¹Waterborne polyester as described in US 2015/0210883 A1, Example H.
²Core shell methane acrylic latex as described in US 2015/0210883 A1, Example G.
³Core/shell acrylic latex as described in US 2015/0210883 A1, Example A.
⁴Polyurethane-acrylic dispersion made of 9.73 wt % adipic acid, 11.30 wt % isophthalic acid, 2.15 wt % maleic anhydride, 21.66 wt % 1,6-hexanediol, 5.95 wt % dimethylolproprionic acid, 1.0 wt % butanediol, 16.07 wt % isophorone diisocyanate, 26.65 wt % butyl acrylate, 2.74 wt % hydroxypropyl methacrylate, and 2.74 wt % ethylene glycol dimethacrylate, with a solids content 45 wt % in deionized water.
⁵Silicone surfactant available from Byk Chemie, GmbH (Wesel, Germany).
⁶Silicone surfactant available from Byk Chemie, GmbH (Wesel, Germany),
⁷Defoamer available from Byk Chemie, GmbH (Wesel, Germany).
⁸Melamine crosslinker available from Allnex USA Inc, (Alpharetta, GA),
⁹Melamine crosslinker available from Allnex USA Inc. (Alpharetta, GA).
¹⁰Melamine crosslinker available from Allnex USA Inc. (Alpharetta, GA).
¹¹Hydrocarbon solvent available from Shell Chemicals LP, USA (Houston, TX).
¹²Aliphatic mineral spirits available from Shell Chemicals LP, USA (Houston, TX),
¹³50% by weight solution of dimethyl ethanolamine on demineralized water.
¹⁴Aqueous black tint paste consisting of 6% by weight carbon black Monarch 1300 dispersed in 17% by weight acrylic polymer blend and having a solids content of 24% by weight.
¹⁵Aqueous white tint paste formed from 61% by weight TiO₂ dispersed in 9% by weight acrylic polymer blend having a solids content of 70% by weight.
¹⁶Polyester as described in U.S. Pat. No. 6,291,564, Example 1.
¹⁷Polypropylene glycol available from Repsol Quimica S.A. (Madrid, Spain).
¹⁸Polyurethane diol prepared by reacting 1 mole of JEFFAMINE D-400 (from Huntsman Chemical Co. (The Woodlands, TX)) with 2 moles of ethylene carbonate at 130° C. as disclosed in Example A of U.S. Pat. No. 7,288,595.
¹⁹Propylene glycol n-butyl ether available from Dow Chemical Co. (Midland, MI).
²⁰Defoamer available from Byk Chemie, GmbH (Wesel, Germany).
²¹Rheology-modifying wax emulsion available from Byk Chernie, GmbH (Wesel, Germany).
²²7% by weight ACRYSOL ASE-60 thickener (available from Dow Chemical Co. (Midland, MI)) in demineralized water.
²³Alkali swellable acrylic emulsion rheology modifier available from BASF SE, Germany (Ludwigshafen, Germany).
²⁴50% by weight tetramethyldecynediol based surfactant from Evonik Industries (Essen, Germany).

### Section 1—Viscosity and Solids

In order to prepare panels for testing of the coating composition of the invention, steel panels coated with a PPG electrodeposition coating (commercially available from ACT panels of Hillsdale, Mich.) were painted by an electrostatic rotary bell applicator in a 3 coating layer stack. The first basecoat (commercially available as Shark Grey High Solids B1 from PPG Industries, Inc. (Pittsburgh, Pa.)) was applied targeting 16-20 microns. After a 340 second flash, the same process was repeated for the second basecoat (Alpine White waterborne basecoat BIPCU300 available from PPG Industries, Inc. (Pittsburgh, Pa.)) targeting 15 to 18 microns, and after a room temperature flash for 335 second, the panels were dehydrated for 6 minutes at 74° C. Finally, a clearcoat (TKAPO1100A and TKAPO B pack commercially available from PPG Industries, Inc. (Pittsburgh, Pa.)) was applied targeting 15 microns for the first pass and 35 microns for the second pass with a 1 minute flash in between. After a 10 minute flash, the panels were cured at 140° C. for 30 minutes.

These horizontally placed panels were then overcoated with the coating compositions of the invention using an Ecopaintjet precision applicator with an 8 nozzle plate (available from Durr Systems AG (Bietigheim-Bissingen, Germany)). A paint pressure of 1.4 bar and a tip speed of 600 mm/s was used, conditions needed to obtain uniform and consistent and parallel paint flow out of each nozzle, and the maximum tip speed to allow the target dry coating film build of 12 microns without disturbing a smooth traverse and therefore smooth paint application. The panels were then flashed for 5 minutes at room temperature, and then cured for 5 minutes at 80° C.

TABLE 2
Viscosity and Solids Data

| | Example | | | | | | |
|---|---|---|---|---|---|---|---|
| | 1 | 2 | 3 | 4 | 5 | 6 | 10 |
| % solids | 10.3 | 11.0 | 11.2 | 11.0 | 11.1 | 11.1 | 25.8 |
| LSV (Pa · s | 0.8 | 3.4 | 5.0 | 10.7 | 18.0 | 23.1 | 2.9 |
| @ 0.1 s−1) | | | | | | | |
| HSV (mPa · s | 41.9 | 64.5 | 77.0 | 101.2 | 124.0 | 139.0 | 84.7 |
| @ 1000 s−1) | | | | | | | |
| Surface Tension | 27.0 | 28.0 | 28.3 | 293 | 30.2 | 30.3 | 28.6 |
| (mN/m) | | | | | | | |
| Substrate | TKAPO | TKAPO | TKAPO | TKAPO | TKAPO | TKAPO | TKAPO |
| Jet stability | OK | OK | Good | Good | No jet | No jet | Poor jet |
| | | | | | stability | stability | |
| Coating | Thin at | Some | Good | Non- | Non- | Non- | Non- |
| appearance | edges | edge | edge | continuous | continuous | continuous | continuous |
| | | thinning | definition | film | film | film | film |
| Final DFT* (μm) | 19 | 16 | 12.5 | 10 | 9 | 8.5 | 26 |

*DFT = dry film thickness

As can be seen in Table 2. Examples 1-6 are all of the same paint solids level but increase in viscosity. Example 1 has too low of viscosity; although the flow from the applicator is smooth, the paint flows off the edges of the panel. Example 2 shows better results, but some paint flow from the panel edge is still observed. Example 3 shows the optimal performance, with uniform jetting, and a continuous film with good edge definition at the target coating dry film thickness. Example 4, although showing uniform and consistent jetting, results in a non-continuous film on the substrate surface. And finally, the highest viscosity Examples 5 and 6, both demonstrate poor jetting consistency and a non-continuous film.

Also, Example 10 in Table 2 shows that although the viscosity is in the target range, the high solids of the paint (25.8%) results in poor jetting, a non-continuous film, and double the target dry film thickness (26 vs. 12 microns). As equipment limitations prevent faster traverse to target lower film builds, optimal results are obtained at much lower solids, in the range of 8 to 12%.

### Examples 13-16

### Surface Tension Results

### Section 2—Surface Tension

The panels were prepared and the experiments were performed as described in Section 1 with the exception that the precision application formulations were applied over both the TKAPO clearcoat (Examples 7-9 and 11) and over the electrodeposition coating (Examples 13-16). Results are shown in Table 3

TABLE 3
Surface Tension Data

| | Example | | | | | | | |
|---|---|---|---|---|---|---|---|---|
| | 7 | 13 | 8 | 14 | 9 | 15 | 11 | 16 |
| Paint example | 7 | | 8 | | 9 | | 11 | |
| % solids | 10.5 | | 13.9 | | 10.0 | | 11.6 | |
| LSV (Pa · s | 5.684 | | 14.9 | | 9.077 | | 11.59 | |
| @ 0.1 s−1) | | | | | | | | |
| HSV (mPa · s | 86.48 | | 90.15 | | 79.2 | | 90.45 | |
| @ 1000 s−1) | | | | | | | | |
| Surface Tension | 27.4 | | 29.2 | | 26.4 | | 25.3 | |
| (mN/m) | | | | | | | | |
| Surface Tension | 0.6 | 6.5 | −1.2 | 4.7 | 1.6 | 7.5 | 2.7 | 8.6 |
| Δ with substrate | | | | | | | | |
| Substrate | TKAPO | Ecoat | TKAPO | Ecoat | TKAPO | Ecoat | TKAPO | Ecoat |
| Jet stability | good | good | good | good | good | good | good | good |
| Coating | De- | good | De- | good | good | good | Good best | good |
| appearance | wetting | | wetting | | | | wetting | |

| | | | | |
|---|---|---|---|---|
| Final DFT (μm) | 10.5 | 10.8 | 13.0 | 15 |

The surface tension of the paint contributes to flow and wetting of the substrate. For the substrates here, the surface energies for the TKAPO and the ecoat panel were determined to be 28.0 and 33.9 mN/m respectively. As seen in Table 3, Examples 7 and 8, with surface tension deltas of 0.6 and −1.2, demonstrate poor substrate wetting (the measurement error of + or −0.3 explains why Example 7 displayed poor wetting). However, Example 9 (surface tension delta of 1.6) shows good wetting, but Example 11 (surface tension delta of 2.7) showed the best wetting with no defects. These examples illustrate the effect of a surface tension difference (substrate surface energy subtracted by paint surface tension) of greater than 0, where greater than 2 provides the optimal result. In addition, for Examples 13 thru 16, where these same paints were coated over the ecoat substrate, all surface tension deltas were above 4.7 (up to 8.6) and all displayed good coating results.

### Section 3—Over Low Temperature Cure Basecoat

### Examples 17

### Preparation of a Latex Having Core-Shell Particles for Low Temperature Cure

Part A: A polyurethane was first prepared by charging the following components in order into a four necked round bottom flask fitted with a thermocouple, mechanical stirrer, and condenser: 134.5 g of butyl acrylate, 10.3 g of hydroxyethyl methacrylate (HEMA), 0.8 g of 2,6-di-tert-butyl 4-methyl phenol, 100.2 g of FOMREZ® 66-56 (hydroxyl terminated saturated linear polyester polyol, commercially available from Chemtura (Philadelphia, Pa.)), 100.2 g of POLYMEG® 2000 polyol (polytetramethylene ether glycol, commercially available from LyondellBasell (Rotterdam, Netherlands)), 33 g of dimethylol propionic acid (DMPA), and 1.6 g of triethylamine. The mixture was heated to 50° C. and held for 15 minutes. After heating the mixture, 140.0 g of isophorone diisocyanate was charged into the flask over 10 minutes and mixed for 15 minutes. Next, 9.7 g of butyl acrylate and 0.40 g of dibutyl tin dilaurate (DBTDL) was charged into the flask. Immediate exotherm was observed. After exotherm subsided, the mixture was heated to 90° C. and held for 60 minutes. The mixture was then cooled to 70° C., and 134.5 g of butyl acrylate and 19.8 g of hexanediol diacrylate were charged into the flask. The mixture was kept at 60° C. before being dispersed into water.

Part B: A latex comprising polyurethane-acrylic core-shell particles with urea linkages and urethane linkages and with keto functionality on the acrylic core and carboxylic acid functionality on the polyurethane shell was prepared by first charging the following components into a four necked round bottom flask fitted with a thermocouple, mechanical stirrer, and condenser: 1000 g of deionized water, 10 g of dimethyl ethanolamine, 4.5 g of ethylenediamine, and 10 g AEROSOL® OT-75 (surfactant, commercially available from Cytec Industries (Woodland Park, N.J.)). The mixture was heated to 50° C. with an N.sub.2 blanket. Next, 650 g of the polyurethane prepared in part A was dispersed into the flask over 20 minutes and mixed for an additional 15 minutes, followed by 20.0 g of diacetone acrylamide and held for 15 minutes. A mixture of 1.0 g of ammonium persulfate, 3.5 g of 35% hydrogen peroxide, and 60 g of deionized water was charged into the flask. The temperature rose from 50° C. to 71° C. due to polymerization exotherm. The mixture was then held at 70° C. for an additional hour. After being cooled to 40° C., 0.2 g of FOAMKILL® 649 (non-silicone defoamer, commercially available from Crucible Chemical Company (Greenville, S.C.)), 5.8 g of ACTICIDE® MBS (microbiocide formed of a mixture of 1,2-benzisothiazolin-3-one and 2-methyl-4-isothiazolin-3-one, commercially available from Thor GmbH (Speyer, Germany)), and 14 g of deionized water were charged and mixed for an additional 15 minutes. The resulting latex had a solids content of 36.4%.

### Examples 18

### Preparation of a Low Temperature Cure Coating Composition

A low temperature cure coating composition was prepared from the components listed in Table 4.

TABLE 4
Low Temperature Cure Coating Composition Formulation

| | Amount |
|---|---|
| Component | (%) |
| Example 17 (Core-shell latex) | 37.2 |
| Adipic dihydrazide | 0.42 |
| CARBODILITE V-02-L2²⁵ | 6.91* |
| BYK 348⁵ | 0.09 |
| BYK 032²⁶ | 0.37 |
| DI Water | 1.07 |
| TINUVIN 1130²⁷ | 0.56 |
| Titanium dioxide | 48.2 |
| Mapico Yellow 1050A²⁸ | 0.21 |
| MONARCH 1300 Black | 0.14 |
| tintpaste²⁹ | |
| BYKETOL WS²⁰ | 2.40 |
| SURYYNOL 104E²⁴ | 2.46 |

*Added before spray out
²⁵Polycarbodiimide at 40 wt % in water available from Nisshinbo Chemicals Inc, (Tokyo, JP),
²⁶Emulsion of paraffin-based mineral oils and hydrophobic components available from BYK Additives and instruments (Wallingford, CT),
²⁷Hydroxphenyl benzotriazole class UV absorber available from BASF (Ludwigshafen, Germany).
²⁸Ferric oxide hydrate pigment available from Huntsman Corporation (The Woodlands, TX).
²⁹Carbon black pigment available from Cabot Corporation (Boston, MA).

Another option, intended to minimize capital expenditure and/or disruption of an existing production line, would be to apply the coating composition of the present invention in the middle of the paint line, after the final conventional basecoat is applied and before the final hardcoat process. The initial attempt (Example 19 in Table 5) resulted in defects after 4 minutes at 80° C. dehydration, and it was found that an unacceptably long basecoat dehydration time of 8 minutes at 80° C. (Example 20) was needed in order to prevent intermixing of the coating invention and related optical defects. However, use of a low temperature cure basecoat as in Example 18, this dehydration time to achieve no intermixing and defect free is significantly reduced.

As seen in Table 5, with use of a low temperature cure white paint (Example 18), a black precision application paint (Example 12) can be applied without intermixing or defects after only 1 minute at 80° C. dehydration (Example 23) or after 4 minutes at 60° C. dehydration (Example 21).

TABLE 5
Black Coating Compositions for Precision Application over Low
Temperature Cure Basecoat

| | Underlying | Oven | Time | Cool down | |
|---|---|---|---|---|---|
| Example | Basecont | T (° C.) | (min.) | (min.) | Result |
| 19 | Conventional | 80 | 4 | 2 | Defects |
| | white paint | | | | |
| 20 | Conventional | 80 | 8 | 2 | No defects |
| | white paint | | | | |
| 21 | Example 18 | 60 | 4 | 1 | No defects |
| 22 | Example 18 | 80 | 2 | 2 | No defects |
| 23 | Example 18 | 80 | 1 | 2 | No defects |

### Example 24

### Viscosity for Vertical Precision Applications

### Section 4—Viscosity for Vertical Application

The panels were prepared and the experiments were performed as described in Section 1 with the exception that the precision application formulations were applied with the substrate in the vertical orientation.

Applying paint to substrates in the vertical orientation requires optimizing the paint rheology, where flow is needed for smooth and consistent transfer from the applicator to the substrate, then flow/leveling for optimal smooth appearance, but too much flow would result in paint sagging down and off the substrate.

The optimal paint for horizontal application, Example 3, was precision applied to substrate in the vertical position. As can be seen from Table 7, the paint flowed well out of the applicator but then flowed too much on the substrate, resulting in a hazy appearance with paint sag/build at the bottom of the substrate. A modified formulation, Example 24 in Table 6, was then applied and resulted in good flow and appearance without sag. It is evident that higher LSV contributes to this optimized result for vertical applications.

TABLE 6
Black Precision Application Coating
Composition for Vertical Surfaces

| | Example |
|---|---|
| Component | 24 |
| Polyester A¹ | 11.3 |
| Latex B³ | 1.4 |
| DAOTAN | 5.6 |
| VTW6462/36WA³⁰ | |
| Deionized water | 41.13 |
| BYK-349⁶ | 0.6 |
| 2-ethylhexanol | 0.9 |
| CYMEL 327⁸ | 1.7 |
| Butyl Carbitol³¹ | 1.7 |
| 2-butoxyethanol | 2.8 |
| 50% DMEA¹³ | 0.9 |
| Black tint¹⁴ | 15.1 |
| DOWANOL PnB¹⁹ | 1.1 |
| LAPONITE | 6.4 |
| solution³² | |
| RHEOVIS AS | 7.4 |
| 1130²³ | |

³⁰Waterborne acrylic-urethane hybrid dispersion available from Allnex USA Inc. (Alpharetta, GA).
³¹diethylene glycol monobutyl ether available from Dow Chemical Co. (Midland, MI).
³²A 2% by weight aqueous solution of LAPONITE RD, available from Southern Clay Products (Gonzales, TX).

TABLE 7
Comparison of Black Precision Application Coating
Composition for Horizontal v. Vertical Surfaces

| | Example | |
|---|---|---|
| | 3 | 24 |
| % solids | 11.2 | 12.2 |
| LSV (Pa · s @ 0.1 s-1) | 5.0 | 23.2 |
| HSV (mPa · s @ | 77.0 | 97.8 |
| 1000 s-1) | | |
| Substrate | TKAPO | TKAPO |
| Jet stability | Good | Good |
| Coating | Hazy with sag | Good with |
| appearance | | no sag |

Whereas particular embodiments of this invention have been described above for purposes of illustration, it will be evident to those skilled in the art that numerous variations of the details of the present invention may be made without departing from the invention as defined in the appended claims.

The invention claimed is:

1. A coating composition for precision application, comprising:
a film-forming resin dispersed in an aqueous medium;
a crosslinker reactive with the film-forming resin;
a rheology modifier;
a colorant; and
a swelling solvent that swells the film-forming resin,
wherein the solids content of the coating composition is less than 25 weight %, based on the total weight of the coating composition.

2. The coating composition of claim 1, wherein the film-forming resin comprises urethane linkages and carboxylic acid and hydroxyl functional groups.

3. The coating composition of claim 2, wherein the film-forming resin comprises a core-shell particle comprising a polymeric core at least partially encapsulated by a polymeric shell comprising the urethane linkages and carboxylic acid and hydroxyl functional groups, and wherein the polymeric shell is covalently bonded to at least a portion of the polymeric core.

4. The coating composition of claim 3, wherein at least a portion of the polymeric core of the core-shell particles comprises an addition polymer formed from (meth)acrylic monomers, vinyl monomers, or combinations thereof.

5. The coating composition of claim 1, wherein the crosslinker comprises an aminoplast.

6. The coating composition of claim 1, wherein the rheology modifier comprises an alkali swellable polymer and a wax.

7. The coating composition of claim 6, wherein the wax of the rheology modifier comprises an ethylene vinyl acetate copolymer wax.

8. The coating composition of claim 1, wherein the colorant comprises a black colorant.

9. The coating composition of claim 1, wherein the swelling solvent comprises at least one alcohol.

10. The coating composition of claim 1, wherein the solids content of the coating composition is from 8 weight % to 12 weight %, based on the total weight of the coating composition.

11. The coating composition of claim 1, wherein the coating composition comprises 20 weight % or less of the rheology modifier, based on the total weight of the coating composition.

12. The coating composition of claim 1, wherein the coating composition has a high-shear viscosity of from 60 to 110 mPa·s at shear rate of 1000 s⁻¹ and/or a low-shear viscosity of from 3 to 32 Pa·s at shear rate of 0.1 s⁻¹, as determine according to ASTM 2196-15 Method B Spindle No LV-1.

13. The coating composition of claim 1, wherein a difference in a surface tension of a substrate coated with a clear topcoat and a surface tension of the coating composition (surface tension (clear coated substrate)−surface tension (coating composition)) is greater than 0.

14. A system for precision application of a coating composition over at least a portion of a substrate, the system comprising:
a coating composition comprising:
a film-forming resin dispersed in an aqueous medium;
a crosslinker reactive with the film-forming resin;
a rheology modifier;
a colorant; and
a swelling solvent that swells the film-forming resin,
wherein the solids content of the coating composition is less than 25 weight %, based on the total weight of the coating composition; and
a device configured to apply the coating composition over at least a portion of the substrate without overspray.

15. The system of claim 14, wherein the device is configured to produce a desired pattern and/or design over the substrate.

16. The system of claim 14, wherein the device is configured to apply the coating composition as a continuous jet, as continuous droplets, and/or as a drop on-demand.

17. The system of claim 14, wherein, when the device is configured to apply the coating composition over the substrate, such that when the coating composition is cured to form a coating, the coating has a dry film thickness of 20 microns or less.

18. A substrate at least partially coated with the coating composition of claim 1.

19. The substrate of claim 18, wherein the substrate comprises a vehicle substrate.

20. A substrate coated with a multi-layer coating system, wherein the multi-layer coating system comprises:
a first basecoat layer positioned over at least a portion of the substrate; and
a second basecoat layer positioned over at least a portion of the first basecoat layer,
wherein the first basecoat layer is formed from a first basecoat composition that when cured to form a layer having a thickness of 35 μm by baking at 80° C. for 30 minutes, the layer achieves 100 MEK double rubs as measured according to ASTM D5402-19,
wherein the second basecoat layer is formed from a second basecoat composition comprising:
a film-forming resin dispersed in an aqueous medium;
a crosslinker reactive with the film-forming resin; and
a colorant;
wherein the solids content of the second basecoat composition is less than 25 weight %, based on the total weight of the second basecoat composition.

21. The substrate of claim 20, wherein the substrate comprises a vehicle substrate.

22. The substrate of claim 20, wherein the first basecoat composition comprises a polyhydrazide-containing curable aqueous composition comprising:
(i) a continuous phase comprising water, and
(ii) a dispersed phase comprising:
(A) polymeric particles prepared from the polymerization of a mixture of ethylenically unsaturated monomer compounds, including ethylenically unsaturated monomers comprising:
(1) a multi-ethylenically unsaturated monomer, and
(2) an aldo or keto group-containing ethylenically unsaturated monomer, and
(B) a hydrophobic polyester prepared from polymerizing the following mixture of monomers:
(I) a polyacid component comprising a dimer fatty acid and a tricarboxylic acid; and
(II) a polyol component comprising a diol and a diol with carboxylic acid groups.

23. The substrate of claim 20, wherein the first basecoat composition comprises an aqueous dispersion comprising an aqueous medium and self-crosslinkable core-shell particles dispersed in the aqueous medium, wherein the core-shell particles comprise (1) a polymeric core at least partially encapsulated by (2) a polymeric shell comprising urethane linkages, keto and/or aldo functional groups, and hydrazide functional groups, and wherein the polymeric core is covalently bonded to at least a portion of the polymeric shell.

24. The substrate of claim 20, wherein the first basecoat composition comprises: a polyhydrazide and core-shell particles dispersed in an aqueous medium, the core-shell particles comprising (1) a polymeric core at least partially encapsulated by (2) a polymeric shell comprising urea linkages, and keto and/or aldo functional groups.

25. The substrate of claim 20, wherein the first basecoat composition comprises:
a free polyisocyanate and hydroxyl functional polymeric core-shell particles, wherein a polymeric core and a polymeric shell of the hydroxyl functional core-shell particles each independently comprise an addition polymer derived from ethylenically unsaturated monomers.

26. The substrate of claim 25, comprising a third basecoat layer positioned over at least a portion of the first basecoat layer and under at least a portion of the second basecoat layer,
wherein the third basecoat layer is formed from a third basecoat composition, wherein the third basecoat composition comprises carboxylic acid functional polymeric core-shell particles, wherein a polymeric core of the carboxylic acid functional core-shell particles comprises an addition polymer derived from ethylenically unsaturated monomers and a polymeric shell of the carboxylic acid functional core-shell particles comprises urethane linkages and carboxylic acid functional groups.

27. The substrate of claim 20, wherein the first basecoat composition comprises:
(a) a melamine resin comprising imino and methylol functional groups that together comprise 30 mole % or greater of the total functionality of the melamine resin; and
(b) at least one polymer reactive with (a) that is obtained from components comprising polytetrahydrofuran and a carboxylic acid or anhydride thereof,
wherein the polytetrahydrofuran comprises greater than 20 weight % of the components that form the polymer (b) and the carboxylic acid or anhydride thereof comprises greater than 5 weight % of the components that form the polymer (b), and
wherein the polymer (b) has an acid value of at least 15 based on the total resin solids of the polymer (b).

28. The substrate of claim 20, wherein the first basecoat composition comprises:
core-shell particles comprising (1) a polymeric acrylic core at least partially encapsulated by (2) a polymeric shell comprising urethane and/or urea linkages, wherein the polymeric shell comprises carboxylic acid functionality, wherein the polymeric core and/or the polymeric shell comprises keto functionality.

29. The substrate of claim 28, wherein the first basecoat composition further comprises a crosslinker.

30. The substrate of claim 20, wherein the first basecoat composition comprises:
a resin comprising self-crosslinkable acrylamide and/or aldehyde and/or azetidine functional groups; and/or
a resin and a crosslinker, wherein the resin and the crosslinker undergo a crosslinking reaction at a temperature of up to 140° C. between:
a carboxylic acid functional group and a carbodiimide, an aziridine, an epoxide, and/or an oxazoline functional group;
an acetoacetyl functional group and an isocyanate, an activated alkene, an aldehyde, and/or an amine functional group;
an amine functional group and an acetylacetonate, an aldehyde, a ketone and/or an epoxide functional group;
an acetal function group and an amine functional group;
a hydroxyl functional group and a protected urethane, an azlactone, and/or a methylol amide functional group;
an azido functional group and a carbon-carbon triple bond;
a thiol functional group and a carbon-carbon double bond; and/or
two functional groups capable of undergoing a Diels-Alder reaction.

31. The substrate of claim 20, wherein the second basecoat composition further comprises:
a rheology modifier; and
a swelling solvent that swells the film-forming resin.

32. A method for precision application of a coating composition over at least a portion of a substrate, comprising:
applying the coating composition according to claim 1 over at least a portion of the substrate with a device configured to apply the coating composition without overspray.

33. The method of claim 32, wherein the coating composition is applied over the substrate in a single pass.

34. The method of claim 32, wherein when the coating composition is applied over the substrate and cured to form a coating, the coating has a dry film thickness of 20 microns or less.

35. The method of claim 32, wherein the substrate is not masked with a removable material during application of the coating composition over the substrate.

36. The method of claim 32, wherein the substrate is positioned substantially vertical relative to the ground, wherein the coating composition has a high-shear viscosity of from 60 to 110 mPa·s at shear rate of 1000 s⁻¹ and/or a low-shear viscosity of from 15 to 32 Pa·s at shear rate of 0.1 s⁻¹, as determine according to ASTM 2196-15 Method B Spindle No LV-1.

37. The method of claim 32, wherein the substrate is positioned substantially horizontal relative to the ground, wherein the coating composition has a high-shear viscosity of from 60 to 100 mPa·s at shear rate of 1000 s⁻¹ and/or a low-shear viscosity of from 3 to 20 Pa·s at shear rate of 0.1 s⁻¹, as determine according to ASTM 2196-15 Method B Spindle No LV-1.

38. The method of claim 32, further comprising:
applying a low temperature cure coating composition that when cured to form a layer having a thickness of 35 μm by baking at 80° C. for 30 minutes, the layer achieves 100 MEK double rubs as measured according to ASTM D5402-19 over at least a portion of the substrate to form a low temperature cure layer, wherein the coating composition is applied over at least a portion of the low temperature cure layer.
